(19) United States
(12) Patent Application Publication
(10) Pub. No.: US 2024/0177919 A1
(43) Pub. Date: May 30, 2024

(54) MAGNETIC COUPLING COIL COMPONENT

(71) Applicant: Taiyo Yuden Co., Ltd., Tokyo (JP)

(72) Inventors: Naoya Terauchi, Tokyo (JP); Natsuko Sato, Tokyo (JP)

(21) Appl. No.: 18/517,042

(22) Filed: Nov. 22, 2023

(30) Foreign Application Priority Data
Nov. 30, 2022 (JP) 2022-191583

(51) Int. Cl. H01F 27/28; H01F 17/00; H01F 27/32

(52) U.S. Cl. CPC H01F 27/2804; H01F 17/0013; H01F 27/32

(57) ABSTRACT

Provided is a magnetic coupling coil component that includes a base containing an insulating material and including a first surface and a second surface facing the first surface, a first coil conductor provided in the base to face the first surface, and a second coil conductor provided in the base to face the second surface. The first coil conductor includes a first conductor pattern including a first circling trajectory portion, and a second conductor pattern that is arranged separately from the first conductor pattern in an axial direction along a coil axis and that includes a second circling trajectory portion. The second coil conductor includes a third conductor pattern including a third circling trajectory portion, and a fourth conductor pattern that is arranged separately from the third conductor pattern in the axial direction and that includes a fourth circling trajectory portion.

### CROSS REFERENCE TO RELATED APPLICATIONS

This application claims priority benefit of Japanese Patent Application No. JP 2022-191583 filed in the Japan Patent Office on Nov. 30, 2022. Each of the above-referenced applications is hereby incorporated herein by reference in its entirety.

### BACKGROUND

The disclosure of the present specification mainly relates to a magnetic coupling coil component. More specifically, the disclosure of the present specification relates to a magnetic coupling coil component suitable for a high frequency circuit. The disclosure of the present specification also relates to an array coil component including a plurality of magnetic coupling coils.

A magnetic coupling coil component includes two or more coil conductors electrically insulated from each other in a base and magnetically coupled to each other, as described in Japanese Patent Laid-Open No. 2016-131208 (hereinafter, referred to as Patent Document 1). The magnetic coupling coil component is used as, for example, a common mode choke coil, a transformer, or a coupled inductor in a circuit.

Each of the coil conductors included in the magnetic coupling coil component includes a circling portion extending along a circumferential direction about a coil axis, and an extension portion that connects both ends of the circling portion to corresponding external electrodes. The circling portion of the coil component included in the existing magnetic coupling coil component has a relatively large number of turns. For example, the circling portion of each coil inductor is wound around five or more turns in the magnetic coupling coil component disclosed in Patent Document 1.

### SUMMARY

It is generally desirable that the coil conductors be strongly coupled to each other in the magnetic coupling coil component. Therefore, a magnetic coupling coil component with an increased coupling coefficient has been proposed in the past. For example, in Patent Document 1, a pair of coil conductors embedded into a magnetic base are provided such that the winding axes of the coil conductors substantially coincide with each other and the coil conductors come in close contact with each other, thereby realizing a high coupling coefficient.

Coil conductors including circling portions with small numbers of turns (for example, fewer than two turns) are used for the magnetic coupling coil component used in a high frequency circuit. In the past, coupling of the coil conductors including the circling portions with small numbers of turns has not sufficiently been examined.

An object of the technology disclosed in the present specification is to solve or mitigate at least part of the above-mentioned problem. A more specific object of the technology disclosed in the present specification is to increase the magnetic coupling between coil conductors in a magnetic coupling coil component. Another more specific object of the present technology is to increase the magnetic coupling between coil conductors in a magnetic coupling coil component in which the coil conductors include circling portions with small numbers of turns.

Other objects of the present technology will become apparent from the description of the entire specification. The technology disclosed in the present specification may be designed to solve problems figured out from sections other than the “SUMMARY.”

A magnetic coupling coil component according to an embodiment contains an insulating material and includes a base, a first coil conductor, and a second coil conductor. The base includes a first surface and a second surface facing the first surface. The first coil conductor is provided in the base to face the first surface. The second coil conductor is provided in the base to face the second surface.

In one aspect, the first coil conductor includes a first conductor pattern and a second conductor pattern. The first conductor pattern includes a first circling trajectory portion on a first trajectory extending in a circumferential direction about a coil axis. The second conductor pattern is arranged separately from the first conductor pattern in an axial direction along the coil axis. The second conductor pattern includes a second circling trajectory portion on a second trajectory extending in the circumferential direction about the coil axis.

In the one aspect, the first circling trajectory portion includes a first overlapping region facing the second circling trajectory portion in the axial direction, and a first non-overlapping region not facing the second circling trajectory portion in the axial direction. In the one aspect, the second circling trajectory portion includes a second overlapping region facing the first circling trajectory portion in the axial direction, and a second non-overlapping region not facing the first circling trajectory portion in the axial direction.

In the one aspect, the second coil conductor includes a third conductor pattern and a fourth conductor pattern. The third conductor pattern includes a third circling trajectory portion on a third trajectory extending in the circumferential direction about the coil axis. The fourth conductor pattern is arranged separately from the third conductor pattern in the axial direction. The fourth conductor pattern includes a fourth circling trajectory portion on a fourth trajectory extending in the circumferential direction about the coil axis.

In the one aspect, the third circling trajectory portion includes a third overlapping region facing the fourth circling trajectory portion in the axial direction, and a third non-overlapping region not facing the fourth circling trajectory portion in the axial direction. In the one aspect, the fourth circling trajectory portion includes a fourth overlapping region facing the third circling trajectory portion in the axial direction, and a fourth non-overlapping region not facing the third circling trajectory portion in the axial direction.

In the one aspect, the first overlapping region and the second overlapping region face the third non-overlapping region in the axial direction.

According to the embodiment of the technology disclosed in the present specification, the coupling between the coil conductors can be increased in the magnetic coupling coil component.

### BRIEF DESCRIPTION OF THE DRAWINGS

FIG. 1 is a perspective view schematically illustrating a magnetic coupling coil component according to a first embodiment;

FIG. 2A is a plan view illustrating a conductor pattern included in the magnetic coupling coil component of FIG. 1;

FIG. 2B is a plan view illustrating another conductor pattern included in the magnetic coupling coil component of FIG. 1;

FIG. 2C is a plan view illustrating yet another conductor pattern included in the magnetic coupling coil component of FIG. 1;

FIG. 2D is a plan view illustrating yet another conductor pattern included in the magnetic coupling coil component of FIG. 1;

FIG. 3 is a cross-sectional view schematically illustrating a cross section along a line I-I of the magnetic coupling coil component of FIG. 1;

FIG. 4 is a cross-sectional view schematically illustrating a cross section along a line II-II of the magnetic coupling coil component of FIG. 1;

FIG. 5 schematically depicts a flow of a magnetic flux in an existing magnetic coupling coil component;

FIG. 6 is a perspective view schematically illustrating a magnetic coupling coil component according to a second embodiment;

FIG. 7A is a plan view illustrating a conductor pattern included in the magnetic coupling coil component of FIG. 6;

FIG. 7B is a plan view illustrating another conductor pattern included in the magnetic coupling coil component of FIG. 6;

FIG. 7C is a plan view illustrating yet another conductor pattern included in the magnetic coupling coil component of FIG. 6;

FIG. 7D is a plan view illustrating yet another conductor pattern included in the magnetic coupling coil component of FIG. 6;

FIG. 8 is a cross-sectional view schematically illustrating a cross section along a line III-III of the magnetic coupling coil component of FIG. 6;

FIG. 9 is a perspective view illustrating an array coil component according to a fourth embodiment; and

FIG. 10 is a transparent view of the array coil component of FIG. 9 viewed from an upper surface.

### DETAILED DESCRIPTION OF THE PREFERRED EMBODIMENTS

Various embodiments of the present technology will now be described with reference to drawings as necessary. Constituent elements common to a plurality of drawings are provided with the same reference sign throughout the plurality of drawings. Note that, for the convenience of description, the respective drawings may not be depicted in accurate scale. The embodiments described below should not be construed as limiting the claimed technology. Various elements described in the following embodiments may not be essential for the solution of the technology.

### 1. First Embodiment

### 1-1. Basic Structure of Magnetic Coupling Coil Component

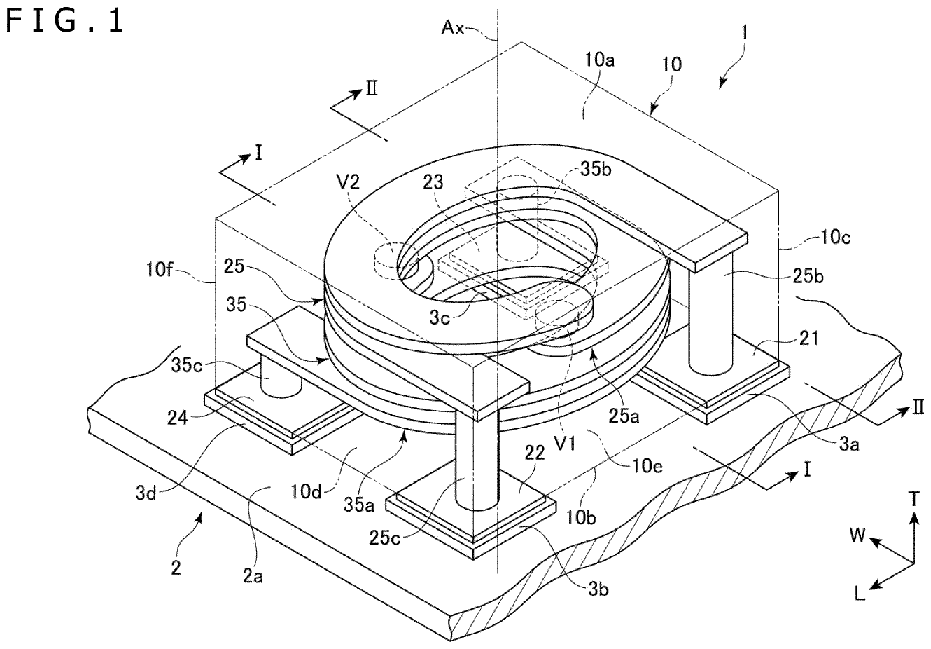

A basic structure of a magnetic coupling coil component 1 according to a first embodiment will be described with reference to FIG. 1. FIG. 1 is a perspective view of the magnetic coupling coil component 1 according to the first embodiment.

The magnetic coupling coil component 1 can be used as a choke coil used in a direct current to a direct current (DC-DC) converter. The magnetic coupling coil component 1 can be applied to a transformer, a coupled inductor, and various other magnetic coupling coil components in addition to the choke coil for the DC-DC converter.

The magnetic coupling coil component 1 includes a plurality of coil conductors magnetically coupled to each other. In the illustrated example, the magnetic coupling coil component 1 includes two coil conductors. More specifically, the magnetic coupling coil component 1 illustrated in FIG. 1 includes a base 10, a first coil conductor 25 provided in the base 10, a second coil conductor 35 provided in the base 10, a first external electrode 21 connected to one end of the first coil conductor 25, a second external electrode 22 connected to the other end of the first coil conductor 25, a third external electrode 23 connected to one end of the second coil conductor 35, and a fourth external electrode 24 connected to the other end of the second coil conductor 35. The first coil conductor 25 and the second coil conductor 35 are magnetically coupled to each other.

The magnetic coupling coil component 1 can be mounted on a mount board 2a. Land portions 3a and 3b are provided on the mount board 2a. The first external electrode 21, the second external electrode 22, the third external electrode 23, and the fourth external electrode 24 are connected to land portions 3a, 3b, 3c, and 3d, respectively, to mount the coil component 1 on the mount board 2a. A circuit board 2 can include the coil component 1 and the mount board 2a on which the coil component 1 is mounted. The circuit board 2 can be mounted on various electronic devices. Examples of the electronic devices that can be provided with the circuit board 2 include a smartphone, a tablet, a game console, electrical components of a car, a server, and various other electronic devices.

### 1-2. Basic Structure of Base 10

In one aspect, the base 10 is formed into a cuboid shape and contains an insulating material. For example, the dimension in an L-axis direction (length) of the coil component 1 is in a range of 0.5 to 6.0 mm. The dimension in a W-axis direction (width) is in a range of 0.3 to 4.5 mm. The dimension in a T-axis direction (height) is in a range of 0.3 to 4.5 mm. In the one aspect, the length of the coil component 1 may be larger than the width. In the present specification, “cuboid” or “cuboid shape” represents not only “cuboid” in a strict mathematical sense. As described later, corners and/or sides of the base 10 may be curved. The dimension and the shape of the base 10 are not limited to those illustrated in the present specification.

The base 10 includes a first main surface 10a, a second main surface 10b, a first end surface 10c, a second end surface 10d, a first side surface 10e, and a second side surface 10f. Each of the first end surface 10c, the second end surface 10d, the first side surface 10e, and the second side surface 10f is connected to the first main surface 10a and the second main surface 10b. The first end surface 10c connects the first side surface 10e and the second side surface 10f. The second end surface 10d also connects the first side surface 10e and the second side surface 10f. The first main surface 10a and the second main surface 10b are surfaces at both ends in the height direction of the base 10. The first end surface 10c and the second end surface 10d are surfaces at both ends in the length direction of the base 10. The first side surface 10e and the second side surface 10f are surfaces at both ends in the width direction of the base 10. The first main surface 10a is on the upper side of the base 10 as illustrated in FIG. 1, and the first main surface 10a will be referred to as an “upper surface” in some cases. Similarly, the second main surface 10b will be referred to as a “lower surface” or a “bottom surface” in some cases.

In the illustrated embodiment, the first external electrode 21, the second external electrode 22, the third external electrode 23, and the fourth external electrode 24 are provided on the second main surface 10b of the base 10. To mount the coil component 1 on the mount board 2a, the second main surface 10b is arranged to face the mount board 2a. Hence, the second main surface 10b of the base 10 will be referred to as a “mount surface” in some cases. At least one of the first external electrode 21, the second external electrode 22, the third external electrode 23, and the fourth external electrode 24 may be extended to a surface other than the lower surface 10b of the base 10. For example, the first external electrode 21 may be extended to come into contact with not only the lower surface 10b, but also the first end surface 10c.

The upper surface 10a and the lower surface 10b are separated from each other by a distance equal to the height of the base 10. The first end surface 10c and the second end surface 10d are separated from each other by a distance equal to the length of the base 10. The first side surface 10e and the second side surface 10f are separated from each other by a distance equal to the width of the base 10. In the present specification, the “length” direction, the “width” direction, and the “thickness” direction of the magnetic coupling coil component 1 represent the L-axis direction, the W-axis direction, and the T-axis direction of FIG. 1, respectively, unless otherwise understood in context.

The base 10 is produced by using an insulating material excellent in insulation. The base 10 may be created by using a magnetic material. Examples of the magnetic material for the base 10 include a soft magnetic alloy material, a magnetic composite material containing magnetic particles dispersed in a resin, a ferrite material, and any other well-known magnetic materials.

### 1-3. Basic Structure of Coil Conductors

In the illustrated embodiment, the first coil conductor 25 is provided in the base 10 to face the upper surface 10a of the base 10. The second coil conductor 35 is provided in the base 10 to face the lower surface 10b of the base 10. Therefore, the first coil conductor 25 is arranged above the second coil conductor 35 (that is, positive side in T-axis direction). Part of the insulating base 10 is present between the first coil conductor 25 and the second coil conductor 35, and therefore, the first coil conductor 25 and the second coil conductor 35 are electrically insulated in the base 10.

The first coil conductor 25 includes a first circling portion 25a, a first one-end extension portion 25b that connects one end of the first circling portion 25a and the first external electrode 21, and a first other-end extension portion 25c that connects the other end of the first circling portion 25a and the second external electrode 22. Similarly, the second coil conductor 35 includes a second circling portion 35a, a second one-end extension portion 35b that connects one end of the second circling portion 35a and the third external electrode 23, and a second other-end extension portion 35c that connects the other end of the second circling portion 35a and the fourth external electrode 24.

The first circling portion 25a extends in a circumferential direction about a coil axis Ax extending along the T-axis. As with the first circling portion 25a, the second circling portion 35a extends in the circumferential direction about the coil axis Ax. In the illustrated embodiment, the coil axis Ax is parallel to the T-axis. The coil axis Ax may not be parallel to the T-axis. The coil axis Ax intersects the upper surface 10a and the lower surface 10b of the base 10. The details of the first circling portion 25a and the second circling portion 35a will be described later.

The first one-end extension portion 25b extends downward along the T-axis from the one end of the first circling portion 25a. One end of the first one-end extension portion 25b is connected to the one end of the first circling portion 25a. The other end of the first one-end extension portion 25b is exposed outside the base 10 from the lower surface 10b. The first one-end extension portion 25b is connected to the first external electrode 21 at the other end exposed from the lower surface 10b.

The first other-end extension portion 25c extends downward along the T-axis from the other end of the first circling portion 25a. One end of the first other-end extension portion 25c is connected to the other end of the first circling portion 25a (the end portion opposite to the end portion connected with the first one-end extension portion 25b). The other end of the first other-end extension portion 25c is exposed outside the base 10 from the lower surface 10b. The first other-end extension portion 25c is connected to the second external electrode 22 at the other end exposed from the lower surface 10b.

The second one-end extension portion 35b extends downward along the T-axis from the one end of the second circling portion 35a. One end of the second one-end extension portion 35b is connected to the one end of the second circling portion 35a. The other end of the second one-end extension portion 35b is exposed outside the base 10 from the lower surface 10b. The second one-end extension portion 35b is connected to the third external electrode 23 at the other end exposed from the lower surface 10b.

The second other-end extension portion 35c extends downward along the T-axis from the other end of the second circling portion 35a. One end of the second other-end extension portion 35c is connected to the other end of the second circling portion 35a (the end portion opposite to the end portion connected with the second one-end extension portion 35b). The other end of the second other-end extension portion 35c is exposed outside the base 10 from the lower surface 10b. The second other-end extension portion 35c is connected to the fourth external electrode 24 at the other end exposed from the lower surface 10b.

As described above, each of the first external electrode 21, the second external electrode 22, the third external electrode 23, and the fourth external electrode 24 is provided on the lower surface 10b of the base 10 in the illustrated embodiment, and each of the first one-end extension portion 25b, the first other-end extension portion 25c, the second one-end extension portion 35b, and the second other-end extension portion 35c is extended to the lower surface 10b and connected to a corresponding external electrode. In this way, the first coil conductor 25 is extended from the lower surface 10b of the base 10 according to the illustrated embodiment. Therefore, a current path from the land portion 3a to the land portion 3b through the first external electrode 21, the first coil conductor 25, and the second external electrode 22 can be shorter than that in a mode in which the first coil conductor 25 is extended from a surface other than the lower surface 10b of the base 10. This can reduce the DC resistance (Rdc) of circuit elements including the first coil conductor 25. Similarly, the second coil conductor 35 is extended from the lower surface 10b of the base 10 according to the illustrated embodiment. Therefore, a current path from the land portion 3c to the land portion 3d through the third external electrode 23, the second coil conductor 35, and the fourth external electrode 24 can be shorter than that in a mode in which the second coil conductor 35 is extended from a surface other than the lower surface 10b of the base 10. This can reduce the DC resistance (Rdc) of circuit elements including the second coil conductor 35.

The surface of the first coil conductor 25 and the surface of the second coil conductor 35 may be covered by insulating films (not illustrated) containing an insulating material excellent in insulation. The insulating films may be oxide films formed on the surface of the first coil conductor 25 and the surface of the second coil conductor 35 in heating processing of the manufacturing process of the coil component 1. The insulating films may be coating films containing a resin excellent in insulation, such as polyurethane, polyamide-imide, polyimide, polyester, and polyester-imide.

### 1-4. Specific Description of Magnetic Coupling Coil Component 1

### 1-4-1. Description of Base 10

In the one aspect, the base 10 is a laminated body including a plurality of laminated magnetic films. As described later, the base 10 may be a laminated body including a magnetic film provided on the surface with a conductor pattern corresponding to the first circling portion 25a, a magnetic film provided on the surface with a conductor pattern corresponding to the second circling portion 35a, and other magnetic films. A region between the first coil conductor 25 and the upper surface 10a in the base 10 is called an upper cover portion. The upper cover portion may be a laminated body including a plurality of laminated magnetic films. A region between the second coil conductor 35 and the lower surface 10b in the base 10 is called a lower cover portion. The lower cover portion may be a laminated body including a plurality of laminated magnetic films. The magnetic films included in the lower cover portion are provided with through holes through which the first one-end extension portion 25b, the first other-end extension portion 25c, the second one-end extension portion 35b, and the second other-end extension portion 35c penetrate.

The thickness (dimension in T-axis direction) of each region of the base 10 can be changed according to the number of magnetic films or the film thickness. For example, the thickness of each of the upper cover portion and the lower cover portion can be adjusted through the number of magnetic films included in each of the upper cover portion and the lower cover portion and/or the film thickness per magnetic film.

In the illustrated embodiment, the magnetic films of the base 10 include magnetic films 11a, 11b, 11c, and 11d. However, the boundaries of the magnetic films 11a to 11d may not visually be recognized by scanning electron microscope (SEM) observation of the cross section of the base 10. A region with the laminated magnetic films 11a to 11d in the base 10 is called a body portion. In this way, the base 10 includes the body portion, the upper cover portion arranged on the upper side of the body portion, and the lower cover portion arranged on the lower side of the body portion.

Conductor patterns as part of the first coil conductor 25 and the second coil conductor 35 are formed on upper surfaces of the magnetic films 11a to 11d. Through holes penetrating the magnetic films in the T-axis direction are formed at predetermined positions of the magnetic films 11a to 11d, and via conductors are embedded into the through holes. The conductor patterns and the via conductors included in the coil component 1 are formed by using screen printing to print a conductive paste containing a metal or an alloy excellent in conductivity, on magnetic sheets as precursors of the magnetic films 11a to 11d, and heating the conductive paste printed on the magnetic sheets. Examples of the material of the conductive paste include Ag, Pd, Cu, Al, and an alloy of these. The conductor patterns and the via conductors included in the coil component 1 may be formed of a material other than these. Examples of the method of forming the conductor patterns and the via conductors included in the coil component 1 include a sputtering method, an inkjet method, and other well-known methods.

### 1-4-2. Specific Description of Coil Conductors

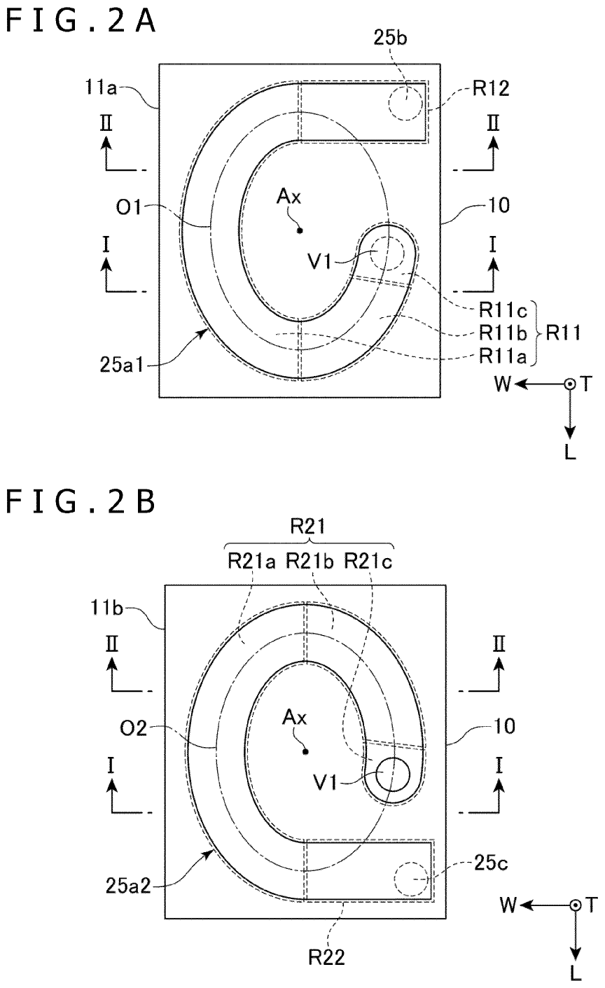

The coil conductors included in the magnetic coupling coil component 1 will further be described with reference to FIGS. 2A to 2D. FIG. 2A illustrates a first upper conductor pattern 25a1 included in the first circling portion 25a of the first coil conductor 25, and FIG. 2B illustrates a first lower conductor pattern 25a2 included in the first circling portion 25a of the first coil conductor 25. FIG. 2C illustrates a second upper conductor pattern 35a1 included in the second circling portion 35a of the second coil conductor 35, and FIG. 2D illustrates a second lower conductor pattern 35a2 included in the second circling portion 35a of the second coil conductor 35.

### 1-4-2-1. Structure of First Coil Conductor 25

The first coil conductor 25 will first be described with reference to FIGS. 2A and 2B.

As illustrated in FIG. 2A, the first upper conductor pattern 25a1 is formed on the upper surface of the magnetic film 11a. The first upper conductor pattern 25a1 includes a first circling trajectory portion R11 on a first trajectory O1 extending in the circumferential direction about the coil axis Ax, and a first connection portion R12 linearly extending between one end of the first circling trajectory portion R11 and the first one-end extension portion 25b. In the illustrated embodiment, the first trajectory O1 is an ellipse. The number of turns that the first circling trajectory portion R11 extends along the first trajectory O1 about the coil axis Ax is equal to or smaller than one. The first connection portion R12 comes off from the first trajectory O1 and extends linearly. In the one aspect, the first upper conductor pattern 25a1 is divided into the first circling trajectory portion R11 and the first connection portion R12.

A through hole penetrating the magnetic film 11a in the T-axis direction is provided in a region of the magnetic film 11a overlapping one end of the first upper conductor pattern 25a1, and a via conductor V1 is embedded into the through hole. The via conductor V1 is connected to the first upper conductor pattern 25a1. A through hole penetrating the magnetic film 11a in the T-axis direction is provided in a region of the magnetic film 11a overlapping the first connection portion R12, and a via conductor as part of the first one-end extension portion 25b is embedded into the through hole.

As illustrated in FIG. 2B, the first lower conductor pattern 25a2 is formed on the upper surface of the magnetic film 11b. The first lower conductor pattern 25a2 includes a second circling trajectory portion R21 on a second trajectory O2 extending in the circumferential direction about the coil axis Ax, and a second connection portion R22 linearly extending between one end of the second circling trajectory portion R21 and the first other-end extension portion 25c. The number of turns that the second circling trajectory portion R21 extends along the second trajectory O2 about the coil axis Ax is equal to or smaller than one. One end of the first lower conductor pattern 25a2 is connected to the via conductor V1, and the other end of the first lower conductor pattern 25a2 is connected to the first other-end extension portion 25c. The second connection portion R22 comes off from the second trajectory O2 and extends linearly. In the one aspect, the first lower conductor pattern 25a2 is divided into the second circling trajectory portion R21 and the second connection portion R22.

In the one aspect, the second connection portion R22 extends in a direction parallel to the first connection portion R12.

In this way, the first lower conductor pattern 25a2 in the axial direction (T-axis direction) along the coil axis Ax is arranged separately from the first upper conductor pattern 25a1 on the negative side in the T-axis direction. The first upper conductor pattern 25a1 and the first lower conductor pattern 25a2 are connected to each other by the via conductor V1.

A through hole penetrating the magnetic film 11b in the T-axis direction is provided in a region of the magnetic film 11b overlapping the second connection portion R22, and a via conductor as part of the first other-end extension portion 25c is embedded into the through hole.

In the illustrated embodiment, the first trajectory O1 and the second trajectory O2 have the same elliptical shape. The shape of the first trajectory O1 and the second trajectory O2 is not limited to the elliptical shape. For example, the shape of the first trajectory O1 and the second trajectory O2 may be an oval, a circle, a rectangle, a polygon, or other shapes in plan view.

In the one aspect, the first circling trajectory portion R11 of the first upper conductor pattern 25a1 is divided into a first overlapping region R11a facing the second circling trajectory portion R21 of the first lower conductor pattern 25a2 in the axial direction along the coil axis Ax, a first non-overlapping region R11b not facing the second circling trajectory portion R21 of the first lower conductor pattern 25a2 in the axial direction along the coil axis Ax, and a first linked region R11c linked to the via conductor V1. The first overlapping region R11a, the first non-overlapping region R11b, and the first linked region R11c are arranged counterclockwise in this order on the first trajectory O1. In the illustrated embodiment, the first overlapping region R11a is rolled up approximately 0.5 turns in the circumferential direction about the coil axis Ax (approximately 180° in the circumferential direction about the coil axis Ax). In the illustrated embodiment, the first non-overlapping region R11b is rolled up approximately 0.2 turns in the circumferential direction about the coil axis Ax. The numbers of turns of the first overlapping region R11a and the first non-overlapping region R11b are not limited to the numbers of turns explicitly illustrated in the present specification, and the numbers of turns can appropriately be set.

In the one aspect, the second circling trajectory portion R21 of the first lower conductor pattern 25a2 is divided into a second overlapping region R21a facing the first circling trajectory portion R11 of the first upper conductor pattern 25a1 in the axial direction along the coil axis Ax, a second non-overlapping region R21b not facing the first circling trajectory portion R11 of the first upper conductor pattern 25a1 in the axial direction along the coil axis Ax, and a second linked region R21c linked to the via conductor V1. The second overlapping region R21a, the second non-overlapping region R21b, and the second linked region R21c are arranged clockwise in this order on the second trajectory O2. In the illustrated embodiment, the second overlapping region R21a is rolled up approximately 0.5 turns in the circumferential direction about the coil axis Ax. In the illustrated embodiment, the second non-overlapping region R21b is rolled up approximately 0.25 turns in the circumferential direction about the coil axis Ax. The numbers of turns of the second overlapping region R21a and the second non-overlapping region R21b are not limited to the numbers of turns explicitly illustrated in the present specification, and the numbers of turns can appropriately be set.

In the illustrated embodiment, the first overlapping region R11a faces the second overlapping region R21a in the axial direction along the coil axis Ax. In other words, the first overlapping region R11a and the second overlapping region R21a overlap as viewed in the T-axis direction. When the first circling trajectory portion R11 and the second circling trajectory portion R21 are viewed in the T-axis direction, not only the first overlapping region R11a and the second overlapping region R21a overlap, but also the first linked region R11c overlaps the second linked region R21c. The overlap of the first overlapping region R11a and the second overlapping region R21a and the overlap of the first linked region R11c and the second linked region R21c vary depending on whether or not the regions in the overlapping relation are electrically directly connected to each other. That is, part of the insulating base 10 is present between the first overlapping region R11a and the second overlapping region R21a in the T-axis direction, and the first overlapping region R11a and the second overlapping region R21a are not electrically directly linked to each other. On the other hand, the first linked region R11c and the second linked region R21c are directly electrically connected to each other by the via conductor V1 extending in the T-axis direction.

In the illustrated embodiment, the first non-overlapping region R11b does not face the second non-overlapping region R21b in the axial direction along the coil axis Ax. In other words, the first non-overlapping region R11b and the second non-overlapping region R21b do not overlap as viewed in the T-axis direction.

As described above, the first upper conductor pattern 25a1 and the first lower conductor pattern 25a2 are connected to each other by the via conductor V1. The first upper conductor pattern 25a1, the via conductor V1, and the first lower conductor pattern 25a2 connected to each other in this way are included in the first circling portion 25a of the first coil conductor 25.

In the one aspect, the number of turns of the first circling portion 25a is smaller than two. The first coil conductor 25 needs to have a small inductance value when, for example, the magnetic coupling coil component 1 is used in a high frequency circuit. The number of turns of the first circling portion 25a is set to smaller than two to obtain the small inductance value.

### 1-4-2-2. Structure of Second Coil Conductor 35

The second coil conductor 35 will next be described with reference to FIGS. 2C and 2D.

As illustrated in FIG. 2C, the second upper conductor pattern 35a1 is formed on the upper surface of the magnetic film 11c. The second upper conductor pattern 35a1 includes a third circling trajectory portion R31 on a third trajectory O3 extending in the circumferential direction about the coil axis Ax, and a third connection portion R32 linearly extending between one end of the third circling trajectory portion R31 and the second one-end extension portion 35b. In the illustrated embodiment, the third trajectory O3 is an ellipse. The number of turns that the third circling trajectory portion R31 extends along the third trajectory O3 about the coil axis Ax is equal to or smaller than one. The third connection portion R32 comes off from the third trajectory O3 and extends linearly. In the one aspect, the second upper conductor pattern 35a1 is divided into the third circling trajectory portion R31 and the third connection portion R32.

A through hole penetrating the magnetic film 11c in the T-axis direction is provided in a region of the magnetic film 11c overlapping one end of the second upper conductor pattern 35a1, and a via conductor V2 is embedded into the through hole. The via conductor V2 is connected to the second upper conductor pattern 35a1. A through hole penetrating the magnetic film 11c in the T-axis direction is provided in a region of the magnetic film 11c overlapping the third connection portion R32, and a via conductor as part of the second one-end extension portion 35b is embedded into the through hole.

As illustrated in FIG. 2D, the second lower conductor pattern 35a2 is formed on the upper surface of the magnetic film 11d. The second lower conductor pattern 35a2 includes a fourth circling trajectory portion R41 on a fourth trajectory O4 extending in the circumferential direction about the coil axis Ax, and a fourth connection portion R42 linearly extending between one end of the fourth circling trajectory portion R41 and the second other-end extension portion 35c. The number of turns that the fourth circling trajectory portion R41 extends along the fourth trajectory O4 about the coil axis Ax is equal to or smaller than one. One end of the second lower conductor pattern 35a2 is connected to the via conductor V2, and the other end of the second lower conductor pattern 35a2 is connected to the second other-end extension portion 35c. The fourth connection portion R42 comes off from the fourth trajectory O4 and extends linearly. In the one aspect, the second lower conductor pattern 35a2 is divided into the fourth circling trajectory portion R41 and the fourth connection portion R42.

In the one aspect, the fourth connection portion R42 extends in a direction parallel to the third connection portion R32.

In the illustrated embodiment, the second upper conductor pattern 35a1 has a shape symmetrical to the first upper conductor pattern 25a1 with respect to a line passing through the coil axis Ax and extending along the L-axis. The second lower conductor pattern 35a2 has a shape symmetrical to the first lower conductor pattern 25a2 with respect to a line passing through the coil axis Ax and extending along the L-axis.

In this way, the second lower conductor pattern 35a2 in the axial direction (T-axis direction) along the coil axis Ax is arranged separately from the second upper conductor pattern 35a1 on the negative side in the T-axis direction. The second upper conductor pattern 35a1 and the second lower conductor pattern 35a2 are connected to each other by the via conductor V2.

A through hole penetrating the magnetic film 11d in the T-axis direction is provided in a region of the magnetic film 11d overlapping the fourth connection portion R42, and a via conductor as part of the second other-end extension portion 35c is embedded into the through hole.

In the illustrated embodiment, the third trajectory O3 and the fourth trajectory O4 have the same elliptical shape. The third trajectory O3 and the fourth trajectory O4 may have the same shape. The third trajectory O3 and the fourth trajectory O4 may have the same shape as the shape of the first trajectory O1 and the second trajectory O2. The shape of the third trajectory O3 and the fourth trajectory O4 is not limited to the elliptical shape. For example, the shape of the third trajectory O3 and the fourth trajectory O4 may be an oval, a circle, a rectangle, a polygon, or other shapes in plan view.

In the one aspect, the third circling trajectory portion R31 of the second upper conductor pattern 35a1 is divided into a third overlapping region R31a facing the fourth circling trajectory portion R41 of the second lower conductor pattern 35a2 in the axial direction along the coil axis Ax, a third non-overlapping region R31b not facing the fourth circling trajectory portion R41 of the second lower conductor pattern 35a2 in the axial direction along the coil axis Ax, and a third linked region R31c linked to the via conductor V2. The third overlapping region R31a, the third non-overlapping region R31b, and the third linked region R31c are arranged clockwise in this order on the third trajectory O3. In the illustrated embodiment, the third overlapping region R31a is rolled up approximately 0.5 turns (180°) in the circumferential direction about the coil axis Ax. In the illustrated embodiment, the third non-overlapping region R31b is rolled up approximately 0.2 turns in the circumferential direction about the coil axis Ax. The numbers of turns of the third overlapping region R31a and the third non-overlapping region 31b are not limited to the numbers of turns explicitly illustrated in the present specification, and the numbers of turns can appropriately be set.

In the one aspect, the fourth circling trajectory portion R41 of the second lower conductor pattern 35a2 is divided into a fourth overlapping region R41a facing the third circling trajectory portion R31 of the second upper conductor pattern 35a1 in the axial direction along the coil axis Ax, a fourth non-overlapping region R41b not facing the third circling trajectory portion R31 of the second upper conductor pattern 35a1 in the axial direction along the coil axis Ax, and a fourth linked region R41c linked to the via conductor V2. The fourth overlapping region R41a, the fourth non-overlapping region R41b, and the fourth linked region R41c are arranged counterclockwise in this order on the fourth trajectory O4. In the illustrated embodiment, the fourth overlapping region R41a is rolled up approximately 0.5 turns in the circumferential direction about the coil axis Ax. In the illustrated embodiment, the fourth non-overlapping region R41b is rolled up approximately 0.25 turns in the circumferential direction about the coil axis Ax. The numbers of turns of the fourth overlapping region R41a and the fourth non-overlapping region R41b are not limited to the numbers of turns explicitly illustrated in the present specification, and the numbers of turns can appropriately be set.

In the illustrated embodiment, the third overlapping region R31a faces the fourth overlapping region R41a in the axial direction along the coil axis Ax. In other words, the third overlapping region R31a and the fourth overlapping region R41a overlap as viewed in the T-axis direction. When the third circling trajectory portion R31 and the fourth circling trajectory portion R41 are viewed in the T-axis direction, not only the third overlapping region R31a and the fourth overlapping region R41a overlap, but also the third linked region R31c overlaps the fourth linked region R41c. The overlap of the third overlapping region R31a and the fourth overlapping region R41a and the overlap of the third linked region R31c and the fourth linked region R41c vary depending on whether or not the regions in the overlapping relation are electrically directly connected to each other. That is, part of the insulating base 10 is present between the third overlapping region R31a and the fourth overlapping region R41a in the T-axis direction, and therefore, the third overlapping region R31a and the fourth overlapping region R41a are not electrically directly linked to each other. On the other hand, the third linked region R31c and the fourth linked region R41c are directly electrically connected to each other by the via conductor V2 extending in the T-axis direction.

In the illustrated embodiment, the third non-overlapping region R31b does not face the fourth non-overlapping region R41b in the axial direction along the coil axis Ax. In other words, the third non-overlapping region R31b and the fourth non-overlapping region R41b do not overlap as viewed in the T-axis direction.

As described above, the second upper conductor pattern 35a1 and the second lower conductor pattern 35a2 are connected to each other by the via conductor V2. The second upper conductor pattern 35a1, the via conductor V2, and the second lower conductor pattern 35a2 connected to each other in this way are included in the second circling portion 35a of the second coil conductor 35.

In the one aspect, the number of turns of the second circling portion 35a is smaller than two. The second coil conductor 35 needs to have a small inductance value when, for example, the magnetic coupling coil component 1 is used in a high frequency circuit. The number of turns of the second circling portion 35a is set to smaller than two to obtain the small inductance value.

As in the illustrated example, the first circling portion 25a with the number of turns smaller than two is obtained by using the via conductor to join the conductor patterns formed across two layers. Similarly, the second circling portion 35a with the number of turns smaller than two is obtained by using the via conductor to join the conductor patterns formed across two layers. Therefore, two magnetic films can be laminated to obtain the first circling portion 25a, and other two magnetic films can be laminated to obtain the second circling portion 35a. On the other hand, if the number of turns is equal to or greater than two, conductor patterns formed on three or more magnetic films need to be connected to one another by via conductors. As a result of setting the number of turns of each of the first circling portion 25a and the second circling portion 35a to smaller than two, the number of magnetic films included in each of the first circling portion 25a and the second circling portion 35a can be two. This can reduce the height of the magnetic coupling coil component 1 compared to a mode in which the numbers of turns of the first circling portion 25a and the second circling portion 35a are equal to or greater than two.

As can be understood from FIGS. 2B to 2D, the through holes for embedding the via conductors included in the first one-end extension portion 25b are formed not only on the magnetic film 11a, but also on each of the magnetic films 11b to 11d, and the via conductors are embedded into the through holes. Although not illustrated, the through holes for embedding the via conductors included in the first one-end extension portion 25b are also formed on the respective magnetic films included in the lower cover portion, and the via conductors are embedded into the through holes. The via conductors embedded into the through holes are formed at the same position in plan view, and therefore, the via conductors adjacent to each other in the T-axis direction are electrically connected to each other. In this way, the via conductors embedded into the through holes formed on the magnetic films 11a to 11d and on the magnetic films included in the lower cover portion are joined to form the first one-end extension portion 25b. The first other-end extension portion 25c, the second one-end extension portion 35b, and the second other-end extension portion 35c are also formed by joining the via conductors embedded into the magnetic films, as with the first one-end extension portion 25b.

The first upper conductor pattern 25a1, the first lower conductor pattern 25a2, the second upper conductor pattern 35a1, and the second lower conductor pattern 35a2 may have uniform widths. The widths of the first upper conductor pattern 25a1, the first lower conductor pattern 25a2, the second upper conductor pattern 35a1, and the second lower conductor pattern 35a2 may be equal to each other. The widths of the first upper conductor pattern 25a1, the first lower conductor pattern 25a2, the second upper conductor pattern 35a1, and the second lower conductor pattern 35a2 represent the dimensions in directions orthogonal to the first trajectory O1, the second trajectory O2, the third trajectory O3, and the fourth trajectory O4, respectively.

### 1-4-3. Magnetic Coupling of First Coil Conductor and Second Coil Conductor

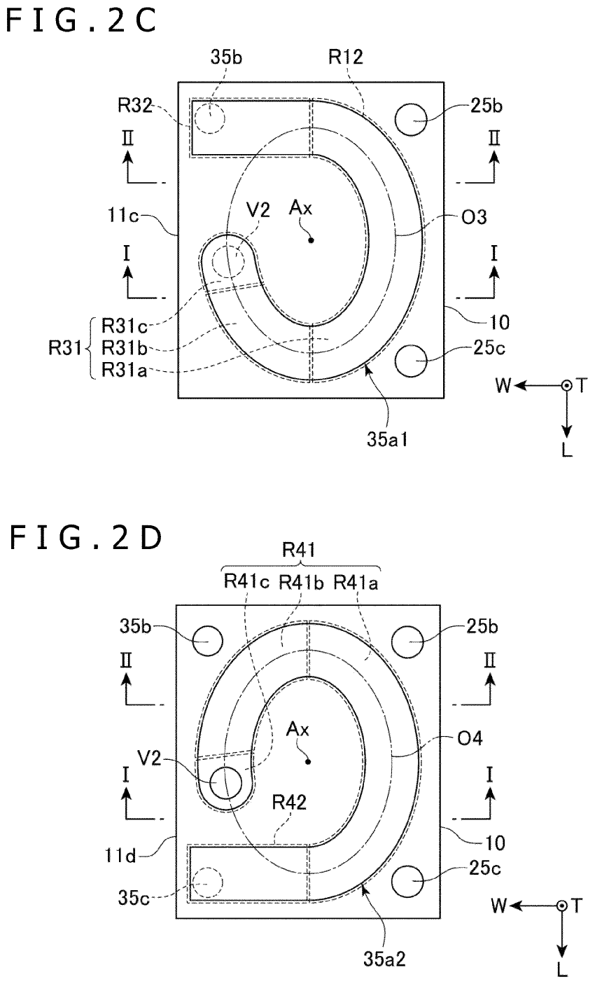

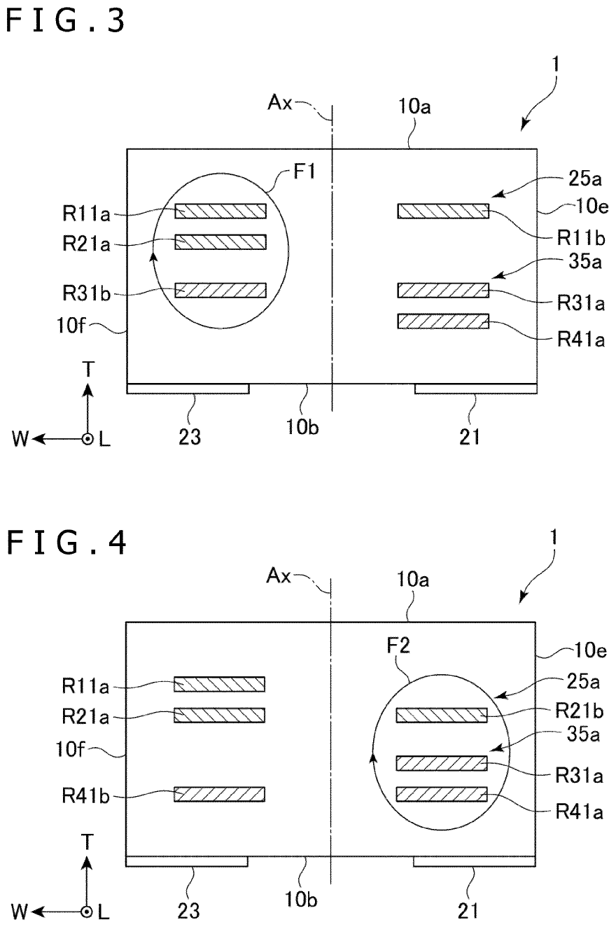

Next, the magnetic coupling of the first coil conductor 25 and the second coil conductor 35 will be described mainly with reference to FIGS. 3 and 4. FIG. 3 illustrates a cross section of the magnetic coupling coil component 1 taken along a line I-I. FIG. 4 illustrates a cross section of the magnetic coupling coil component 1 taken along a line II-II. FIGS. 3 and 4 illustrate cross sections of the magnetic coupling coil component 1 cut in a plane parallel to a WT surface.

As illustrated in FIG. 3, the first overlapping region R11a and the second overlapping region R21a face the third non-overlapping region R31b in the axial direction (T-axis direction) along the coil axis Ax. As described above, the third non-overlapping region R31b does not face the fourth circling trajectory portion R41 of the second lower conductor pattern 35a2, and therefore, the conductor pattern included in the second lower conductor pattern 35a2 is not arranged below the third non-overlapping region R31b in the T-axis direction. An interlinkage flux F1 generated from the first overlapping region R11a and the second overlapping region R21a due to a change in the current flowing through the first coil conductor 25 can pass below the third non-overlapping region R31b, which is part of the second upper conductor pattern 35a1 arranged above the second lower conductor pattern 35a2, and return to near the first coil conductor 25 without advancing to below the second lower conductor pattern 35a2. In this way, according to the magnetic coupling coil component 1, the first overlapping region R11a and the second overlapping region R21a face the third non-overlapping region R31b in the axial direction along the coil axis Ax, and therefore, the length of the magnetic path of the interlinkage flux generated from the first coil conductor 25 and interlinked with the second coil conductor 35 can be shorter than that in a mode in which the interlinkage flux generated from the first coil conductor 25 passes below the second lower conductor pattern 35a2.

As illustrated in FIG. 4, the third overlapping region R31a and the fourth overlapping region R41a face the second non-overlapping region R21b in the axial direction (T-axis direction) along the coil axis Ax. As described above, the second non-overlapping region R21b does not face the first circling trajectory portion R11 of the first upper conductor pattern 25a1, and therefore, the conductor pattern included in the first upper conductor pattern 25a1 is not arranged above the second non-overlapping region R21b in the T-axis direction. An interlinkage flux F2 generated from the third overlapping region R31a and the fourth overlapping region R41a due to a change in the current flowing through the second coil conductor 35 can pass above the second non-overlapping region R21b, which is part of the first lower conductor pattern 25a2 arranged below the first upper conductor pattern 25a1, and return to near the second coil conductor 35 without advancing to above the first upper conductor pattern 25a1. In this way, according to the magnetic coupling coil component 1, the third overlapping region R31a and the fourth overlapping region R41a face the second non-overlapping region R21b in the axial direction along the coil axis Ax, and therefore, the length of the magnetic path of the interlinkage flux generated from the second coil conductor 35 and interlinked with the first coil conductor 25 can be shorter than that in a mode in which the interlinkage flux generated from the second coil conductor 35 passes above the first upper conductor pattern 25a1.

1-4-4. Comparison with Existing Magnetic Coupling Coil Component

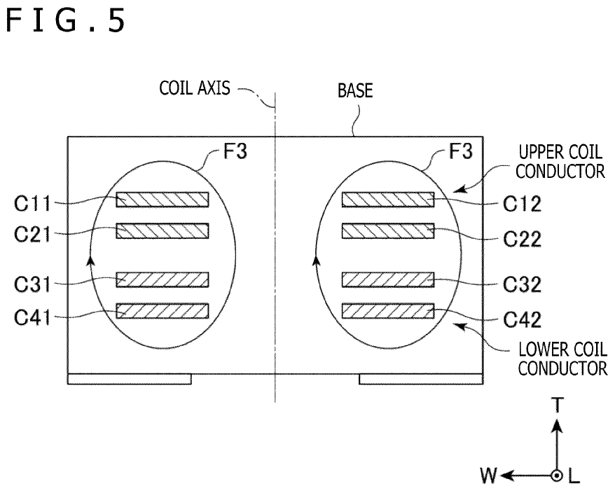

With reference to FIG. 5, the length of the magnetic path of the interlinkage flux in the magnetic coupling coil component 1 according to the first embodiment will be described in comparison with the length of the magnetic path of the interlinkage flux in an existing magnetic coupling coil component.

As illustrated in FIG. 5, in the existing magnetic coupling coil component including a pair of coil conductors arranged at an upper position and a lower position in the base, the same number of conductor portions are arranged in the direction along the coil axis. In the example of the existing magnetic coupling coil component illustrated in FIG. 5, an upper coil conductor including conductor portions C11, C12, C21, and C22 and a lower coil conductor including conductor portions C31, C32, C41, and C42 are arranged along the coil axis. In this example, the conductor portions C11 and C21 of the upper coil conductor and the conductor portions C31 and C41 of the lower coil conductor face each other in the axial direction along the coil axis. The conductor portions C12 and C22 of the upper coil conductor and the conductor portions C32 and C42 of the lower coil conductor face each other in the axial direction along the coil axis. That is, the number of the conductor portions C11 and C21 of the upper coil conductor is the same as the number of (two) conductor portions C31 and C41 facing the conductor portions C11 and C21. Further, the number of the conductor portions C12 and C22 of the upper coil conductor is the same as the number of the conductor portions C32 and C42 facing the conductor portions C12 and C22. Therefore, an interlinkage flux F3 generated by a change in the current flowing through the upper coil conductor in the existing magnetic coupling coil component returns to the upper coil conductor after passing further below the conductor portions C41 and C42 below the conductor portions C31 and C32 in the upper layer among the conductor portions included in the lower coil conductor. Similarly, the interlinkage flux F3 generated by a change in the current flowing through the lower coil conductor returns to the lower coil conductor after passing further above the conductor portions C11 and C12 above the conductor portions C21 and C22 in the lower layer among the conductor portions included in the upper coil conductor.

On the other hand, in the magnetic coupling coil component 1 according to the first embodiment, the interlinkage flux F1 generated from the first overlapping region R11a and the second overlapping region R21a in the first coil conductor 25 can pass below the third non-overlapping region R31b in the upper layer of the second coil conductor 35 and return to near the first coil conductor 25 without advancing to below the second lower conductor pattern 35a2 in the lower layer of the second coil conductor 35, as described with reference to FIG. 3. Therefore, the length of the magnetic path of the interlinkage flux F1 generated from the conductor portions corresponding to two turns in the magnetic coupling coil component 1 (the first overlapping region R11a and the second overlapping region R21a in the example of FIG. 3, the third overlapping region R31a and the fourth overlapping region R41a in the example of FIG. 4) can be shorter than the length of the magnetic path of the interlinkage flux F3 generated from the conductor portions corresponding to two turns in the existing magnetic coupling coil component (for example, the conductor portions C11 and C21 in FIG. 5).

In this way, the magnetic path lengths of the interlinkage fluxes F1 and F2 can be shortened in the magnetic coupling coil component 1 according to the first embodiment, and the magnetic coupling of the first coil conductor 25 and the second coil conductor 35 can thus be increased.

### 1-4-5. Difference Between Inductance Values

The numbers of turns of the first coil conductor 25 and the second coil conductor 35 are small, and therefore, the proportion of the circling portion to the entire length of the coil conductor is small. Thus, even if the number of turns of the first circling portion 25a of the first coil conductor 25 and the number of turns of the second circling portion 35a of the second coil conductor 35 are equal to each other, the difference between the entire lengths of the coil conductors becomes large due to the difference between the lengths of the extension portions. Therefore, it is desirable to reduce the difference between self-inductance values caused by the difference between the lengths of the coil conductors in the magnetic coupling coil component in which the coil conductors with small numbers of turns of the circling portions are coupled to each other.

The second circling portion 35a can have a two-layer structure including the second upper conductor pattern 35a1 and the second lower conductor pattern 35a2 in the magnetic coupling coil component 1 according to the first embodiment, and therefore, the difference between the length of the first one-end extension portion 25b and the first other-end extension portion 25c and the length of the second one-end extension portion 35b and the second other-end extension portion 35c can be reduced.

The present inventors have performed a simulation to verify the inductance value of the first coil conductor 25 and the inductance value of the second coil conductor 35 in the magnetic coupling coil component 1. Specifically, the present inventors have set the magnetic coupling coil component 1 illustrated in FIGS. 1 to 4 in a simulator and have calculated the self-inductance of the first coil conductor 25 and the self-inductance of the second coil conductor 35 in the magnetic coupling coil component 1. As a result, the present inventors have found out that the difference between the inductance value of the first coil conductor 25 and the inductance value of the second coil conductor 35 can be reduced to equal to or smaller than 3% of the inductance value of the first coil conductor 25 in the magnetic coupling coil component 1 including the first coil conductor 25 and the second coil conductor 35 formed and arranged as illustrated in FIGS. 1 to 4.

### 1-4-6 Manufacturing Method

Next, an example of a manufacturing method of the magnetic coupling coil component 1 will be described. The magnetic coupling coil component 1 can be manufactured by, for example, a lamination process. An example of the manufacturing method of the magnetic coupling coil component 1 based on a sheet lamination method will be described below.

First, magnetic sheets as precursors of the magnetic films (including the magnetic films 11a to 11d) of the base 10 are produced. The magnetic sheets are produced by, for example, kneading soft magnetic metal powder and a resin to prepare slurry, applying the slurry to the surfaces of plastic base films according to a doctor blade method or another general method, drying the slurry, and cutting the dried slurry in predetermined sizes.

Next, the through holes penetrating the magnetic sheets in the T-axis direction are formed at predetermined positions of the magnetic sheets as precursors of the magnetic films 11a to 11d. Screen printing is then used to print a conductive paste on the upper surfaces of the magnetic sheets as precursors of the magnetic films 11a to 11d to form unfired conductor patterns on the magnetic sheets, and the conductive paste is embedded into the through holes formed in the magnetic sheets. The unfired conductor pattern formed on the magnetic sheet as a precursor of the magnetic film 11a becomes the first upper conductor pattern 25al after being heated, and the unfired conductor pattern formed on the magnetic sheet as a precursor of the magnetic film 11b becomes the first lower conductor pattern 25a2 after being heated. The unfired conductor pattern formed on the magnetic sheet as a precursor of the magnetic film 11c becomes the second upper conductor pattern 35al after being heated, and the unfired conductor pattern formed on the magnetic sheet as a precursor of the magnetic film 11d becomes the second lower conductor pattern 35a2 after being heated. Various well-known methods other than the screen printing may be used to form the conductor patterns.

The magnetic sheet as a precursor of the magnetic film 11a may be one piece of magnetic sheet or may be a laminated sheet including a plurality of laminated magnetic sheets. Similarly, the magnetic sheet as a precursor of each of the magnetic films 11b to 11d may be one piece of magnetic sheet or may be a laminated sheet including a plurality of laminated magnetic sheets. The number of magnetic sheets included in each of the magnetic films 11a to 11d can be adjusted to adjust the thickness of each of the magnetic films 11a to 11d.

Next, the magnetic sheets as precursors of the magnetic films 11a to 11d, the plurality of magnetic sheets as precursors of the upper cover portion 12, and the plurality of magnetic sheets as precursors of the lower cover portion 13 are laminated to obtain a laminated body. In the laminated body, more magnetic sheets than the magnetic sheets included in the precursors of the lower cover portion 13 can be included in the precursors of the upper cover portion 12 to make a first distance T1 larger than a second distance T2 in the magnetic coupling coil component 1 as a finished product. The laminated magnetic sheets may be heated and pressed by a press machine. Next, a cutting machine such as a dicing machine and a laser processing machine can be used to dice the laminated body in desirable sizes to obtain a chip stack. Polishing processing such as barrel polishing may be applied to end portions of the chip stack as necessary.

The chip stack is then degreased, and heating processing is applied to the degreased chip stack to obtain the base 10. As a result of the heating processing, an oxide layer is formed on the surface of each particle of the soft magnetic metal powder included in the magnetic sheets, and adjacent particles of the soft magnetic metal powder are coupled to each other through the oxide layer. The heating processing of the chip stack is executed for a heating time of 20 to 120 minutes, at a heating temperature of 600° C. to 800° C., for example.

The conductor paste is then applied to the lower surface 10b of the base 10 to form the first external electrode 21, the second external electrode 22, the third external electrode 23, and the fourth external electrode 24. The first external electrode 21, the second external electrode 22, the third external electrode 23, and the fourth external electrode 24 may include plating layers. The plating layers may include two or more layers. The two plating layers may include an Ni plating layer and an Sn plating layer provided outside the Ni plating layer.

The magnetic coupling coil component 1 is obtained in this way. A compression molding method, a thin-film processing method, a slurry building method, or other well-known methods may be used to produce the magnetic coupling coil component 1.

Some of the steps included in the manufacturing method may appropriately be omitted. Steps not explicitly described in the present specification may be executed as necessary in the manufacturing method of the coil component 1. Some of the steps included in the manufacturing method of the coil component 1 may appropriately be switched and executed without departing from the scope of the present technology. Some of the steps included in the manufacturing method of the coil component 1 may be executed at the same time or in parallel if possible.

### 2. Second Embodiment

### 2-1. Description of Magnetic Coupling Coil Component 101

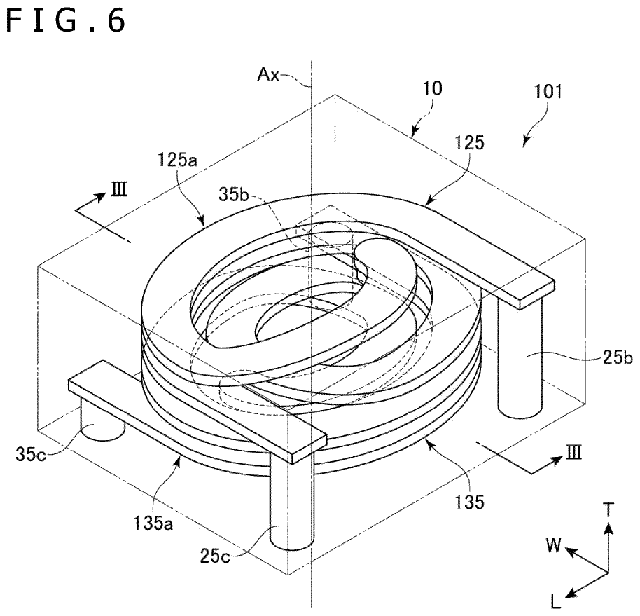

A magnetic coupling coil component 101 according to a second embodiment of the present application will be described with reference to FIGS. 6 to 8. The magnetic coupling coil component 101 according to the second embodiment will be described. The magnetic coupling coil component 101 is different from the magnetic coupling coil component 1 in that the magnetic coupling coil component 101 incudes a first coil conductor 125 in place of the first coil conductor 25 and includes a second coil conductor 135 in place of the second coil conductor 35. The first coil conductor 125 and the second coil conductor 135 included in the magnetic coupling coil component 101 will mainly be described, and the details of the magnetic coupling coil component 101 which are common with the magnetic coupling coil component 1 will not be described.

FIG. 6 is a perspective view of the magnetic coupling coil component 101 according to the second embodiment. The magnetic coupling coil component 101 includes the first coil conductor 125 provided in the base 10 and the second coil conductor 135 provided in the base 10. The first coil conductor 125 and the second coil conductor 135 are magnetically coupled to each other. The first coil conductor 125 is provided in the base 10 to face the upper surface 10a of the base 10. The second coil conductor 135 is provided in the base 10 to face the lower surface 10b of the base 10.

The first coil conductor 125 includes a first circling portion 125a, the first one-end extension portion 25b that connects one end of the first circling portion 125a and the first external electrode 21, and the first other-end extension portion 25c that connects the other end of the first circling portion 125a and the second external electrode 22. The second coil conductor 135 includes a second circling portion 135a, the second one-end extension portion 35b that connects one end of the second circling portion 135a and the third external electrode 23, and the second other-end extension portion 35c that connects the other end of the second circling portion 135a and the fourth external electrode 24.

### 2-2. Specific Description of Coil Conductors

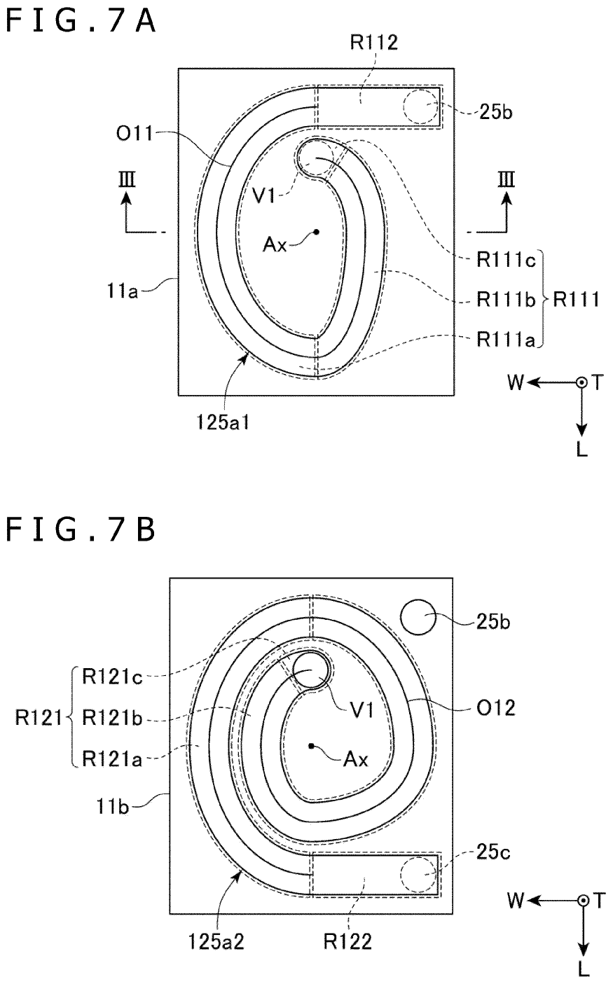

The first coil conductor 125 and the second coil conductor 135 will further be described with reference to FIGS. 7A to 7D. FIG. 7A illustrates a first upper conductor pattern 125a1 included in the first circling portion 125a of the first coil conductor 125. FIG. 7B illustrates a first lower conductor pattern 125a2 included in the first circling portion 125a of the first coil conductor 125. FIG. 7C illustrates a second upper conductor pattern 135a1 included in the second circling portion 135a of the second coil conductor 135. FIG. 7D illustrates a second lower conductor pattern 135a2 included in the second circling portion 135a of the second coil conductor 135.

### 2-2-1. Description of First Coil Conductor 125

The first coil conductor 125 will first be described with reference to FIGS. 7A and 7B.

As illustrated in FIG. 7A, the first upper conductor pattern 125a1 is formed on the upper surface of the magnetic film 11a. The first upper conductor pattern 125a1 includes a first circling trajectory portion R111 on a first trajectory O11 extending in the circumferential direction about the coil axis Ax, and a first connection portion R112 linearly extending between one end of the first circling trajectory portion R111 and the first one-end extension portion 25b. In the illustrated embodiment, the first trajectory O11 has a spiral shape extending about the coil axis Ax. The first connection portion R112 comes off from the first trajectory O11 and extends linearly. In one aspect, the first upper conductor pattern 125a1 is divided into the first circling trajectory portion R111 and the first connection portion R112. One end of the first upper conductor pattern 125a1 is connected to the first one-end extension portion 25b, and the other end of the first upper conductor pattern 125a1 is connected to the via conductor V1.

As illustrated in FIG. 7B, the first lower conductor pattern 125a2 is formed on the upper surface of the magnetic film 11b. The first lower conductor pattern 125a2 includes a second circling trajectory portion R121 on a second trajectory O12 extending in the circumferential direction about the coil axis Ax, and a second connection portion R122 linearly extending between one end of the second circling trajectory portion R121 and the first other-end extension portion 25c. In the illustrated embodiment, the second trajectory O12 has a spiral shape extending about the coil axis Ax. The second connection portion R122 comes off from the second trajectory O12 and extends linearly. In the one aspect, the first lower conductor pattern 125a2 is divided into the second circling trajectory portion R121 and the second connection portion R122. One end of the first lower conductor pattern 125a2 is connected to the via conductor V1, and the other end of the first lower conductor pattern 125a2 is connected to the first other-end extension portion 25c.

In the one aspect, the second connection portion R122 extends in a direction parallel to the first connection portion R112.

In this way, the first lower conductor pattern 125a2 in the axial direction (T-axis direction) along the coil axis Ax is arranged separately from the first upper conductor pattern 125a1 on the negative side in the T-axis direction. The first upper conductor pattern 125a1 and the first lower conductor pattern 125a2 are connected to each other by the via conductor V1.

In the one aspect, the first circling trajectory portion R111 of the first upper conductor pattern 125al is divided into a first overlapping region R111a facing the second circling trajectory portion R121 of the first lower conductor pattern 125a2 in the axial direction along the coil axis Ax, a first non-overlapping region R111b not facing the second circling trajectory portion R121 of the first lower conductor pattern 125a2 in the axial direction along the coil axis Ax, and a first linked region R111c linked to the via conductor V1. The first overlapping region R111a, the first non-overlapping region R111b, and the first linked region R111c are arranged counterclockwise in this order on the first trajectory O11. In the illustrated embodiment, the first overlapping region R111a is rolled up approximately 0.5 turns (180°) in the circumferential direction about the coil axis Ax. In the illustrated embodiment, the first non-overlapping region R111b is rolled up approximately 0.5 turns in the circumferential direction about the coil axis Ax. The numbers of turns of the first overlapping region R111a and the first non-overlapping region 111b are not limited to the numbers of turns explicitly illustrated in the present specification, and the numbers of turns can appropriately be set. In this way, the first circling trajectory portion R111 may extend 0.75 or more turns about the coil axis Ax.

In the one aspect, the second circling trajectory portion R121 of the first lower conductor pattern 125a2 is divided into a second overlapping region R121a facing the first circling trajectory portion R111 of the first upper conductor pattern 125a1 in the axial direction along the coil axis Ax, a second non-overlapping region R121b not facing the first circling trajectory portion R111 of the first upper conductor pattern 125a1 in the axial direction along the coil axis Ax, and a second linked region R121c linked to the via conductor V1. The second overlapping region R121a, the second non-overlapping region R121b, and the second linked region R121c are arranged clockwise in this order on the second trajectory O12. In the illustrated embodiment, the second overlapping region R121a is rolled up 0.5 turns in the circumferential direction about the coil axis Ax. In the illustrated embodiment, the second non-overlapping region R121b is rolled up approximately one turn in the circumferential direction about the coil axis Ax. The numbers of turns of the second overlapping region R121a and the second non-overlapping region R121b are not limited to the numbers of turns explicitly illustrated in the present specification, and the numbers of turns can appropriately be set.

As described above, the second circling trajectory portion R121 is rolled up one or more turns about the coil axis Ax on the magnetic film 11b. The coil rolled up one or more turns on one plane in this way is called a planar coil in some cases. The first lower conductor pattern 125a2 (or the first coil conductor 125 including the first lower conductor pattern 125a2) is an example of the planar coil.

In the illustrated embodiment, the first overlapping region R111a faces the second overlapping region R121a in the axial direction along the coil axis Ax. In other words, the first overlapping region R111a and the second overlapping region R121a overlap as viewed in the T-axis direction. In the illustrated embodiment, the first non-overlapping region R111b does not face the second non-overlapping region R121b in the axial direction along the coil axis Ax. In other words, the first non-overlapping region R111b and the second non-overlapping region R121b do not overlap as viewed in the T-axis direction.

As described above, the first upper conductor pattern 125a1 and the first lower conductor pattern 125a2 are connected to each other by the via conductor V1. The first upper conductor pattern 125a1, the via conductor V1, and the first lower conductor pattern 125a2 connected to each other in this way are included in the first circling portion 125a of the first coil conductor 125.

### 2-2-2. Description of Second Coil Conductor 135

The second coil conductor 135 will next be described with reference to FIGS. 7C and 7D.

As illustrated in FIG. 7C, the second upper conductor pattern 135a1 is formed on the upper surface of the magnetic film 11c. The second upper conductor pattern 135a1 includes a third circling trajectory portion R131 on a third trajectory O13 extending in the circumferential direction about the coil axis Ax, and a third connection portion R132 linearly extending between one end of the third circling trajectory portion R131 and the second one-end extension portion 35b. In the illustrated embodiment, the third trajectory O13 has a spiral shape extending about the coil axis Ax. The third connection portion R132 comes off from the third trajectory O13 and extends linearly. In the one aspect, the second upper conductor pattern 135a1 is divided into the third circling trajectory portion R131 and the third connection portion R132.

As illustrated in FIG. 7D, the second lower conductor pattern 135a2 is formed on the upper surface of the magnetic film 11d. The second lower conductor pattern 135a2 includes a fourth circling trajectory portion R141 on a fourth trajectory O14 extending in the circumferential direction about the coil axis Ax, and a fourth connection portion R142 linearly extending between one end of the fourth circling trajectory portion R141 and the second other-end extension portion 35c. One end of the second lower conductor pattern 135a2 is connected to the via conductor V2, and the other end of the second lower conductor pattern 135a2 is connected to the second other-end extension portion 35c. The fourth connection portion R142 comes off from the fourth trajectory O14 and extends linearly. In the one aspect, the second lower conductor pattern 135a2 is divided into the fourth circling trajectory portion R141 and the fourth connection portion R142.

In the one aspect, the fourth connection portion R142 extends in a direction parallel to the third connection portion R132.

The second lower conductor pattern 135a2 in the axial direction (T-axis direction) along the coil axis Ax is arranged separately from the second upper conductor pattern 135a1 on the negative side in the T-axis direction. The second upper conductor pattern 135a1 and the second lower conductor pattern 135a2 are connected to each other by the via conductor V2.

In the one aspect, the third circling trajectory portion R131 of the second upper conductor pattern 135a1 is divided into a third overlapping region R131a facing the fourth circling trajectory portion R141 of the second lower conductor pattern 135a2 in the axial direction along the coil axis Ax, a third non-overlapping region R131b not facing the fourth circling trajectory portion R141 of the second lower conductor pattern 135a2 in the axial direction along the coil axis Ax, and a third linked region R131c linked to the via conductor V2. The third overlapping region R131a, the third non-overlapping region R131b, and the third linked region R131c are arranged clockwise in this order on the third trajectory O13. In the illustrated embodiment, the third overlapping region R131a is rolled up approximately 0.5 turns (approximately 180°) in the circumferential direction about the coil axis Ax. In the illustrated embodiment, the third non-overlapping region R131b is rolled up approximately one turn in the circumferential direction about the coil axis Ax. The numbers of turns of the third overlapping region R131a and the third non-overlapping region R131b are not limited to the numbers of turns explicitly illustrated in the present specification, and the numbers of turns can appropriately be set.

In the one aspect, the fourth circling trajectory portion R141 of the second lower conductor pattern 135a2 is divided into a fourth overlapping region R141a facing the third circling trajectory portion R131 of the second upper conductor pattern 135a1 in the axial direction along the coil axis Ax, a fourth non-overlapping region R141b not facing the third circling trajectory portion R131 of the second upper conductor pattern 135a1 in the axial direction along the coil axis Ax, and a fourth linked region R141c linked to the via conductor V2. The fourth overlapping region R141a, the fourth non-overlapping region R141b, and the fourth linked region R141c are arranged counterclockwise in this order on the fourth trajectory O14. In the illustrated embodiment, the fourth overlapping region R141a is rolled up 0.5 turns in the circumferential direction about the coil axis Ax. In the illustrated embodiment, the fourth non-overlapping region R141b is rolled up approximately 0.5 turns in the circumferential direction about the coil axis Ax. The numbers of turns of the fourth overlapping region R141a and the fourth non-overlapping region R141b are not limited to the numbers of turns explicitly illustrated in the present specification, and the numbers of turns can appropriately be set.

In the illustrated embodiment, the third overlapping region R131a faces the fourth overlapping region R141a in the axial direction along the coil axis Ax. In other words, the third overlapping region R131a and the fourth overlapping region R141a overlap as viewed in the T-axis direction. In the illustrated embodiment, the third non-overlapping region R131b does not face the fourth non-overlapping region R141b in the axial direction along the coil axis Ax. In other words, the third non-overlapping region R131b and the fourth non-overlapping region R141b do not overlap as viewed in the T-axis direction.

As described above, the second upper conductor pattern 135a1 and the second lower conductor pattern 135a2 are connected to each other by the via conductor V2. The second upper conductor pattern 135a1, the via conductor V2, and the second lower conductor pattern 135a2 connected to each other in this way are included in the second circling portion 135a of the second coil conductor 135.

In the one aspect, the number of turns of the first circling portion 125a is equal to or more than two. Similarly, in the one aspect, the number of turns of the second circling portion 135a is equal to or more than two. The first coil conductor 125 is a planar coil, and therefore, the numbers of turns of the first coil conductor 125 and the second coil conductor 135 can be increased (for example, increased to two or more turns) in the magnetic coupling coil component 101 without increasing the dimension in the height direction. Therefore, an inductance value higher than the inductance value of the magnetic coupling coil component 1 can easily be obtained in the magnetic coupling coil component 101.

The first upper conductor pattern 125a1, the first lower conductor pattern 125a2, the second upper conductor pattern 135a1, and the second lower conductor pattern 135a2 may have uniform widths. The widths of the first upper conductor pattern 125a1, the first lower conductor pattern 125a2, the second upper conductor pattern 135a1, and the second lower conductor pattern 135a2 may be equal to each other. The widths of the first upper conductor pattern 125a1, the first lower conductor pattern 125a2, the second upper conductor pattern 135a1, and the second lower conductor pattern 135a2 represent the dimensions in directions orthogonal to the first trajectory O11, the second trajectory O12, the third trajectory O13, and the fourth trajectory O14, respectively.

The first non-overlapping region R111b crosses the second non-overlapping region R121b of the second circling trajectory portion R121 at one location as viewed in the T-axis direction. That is, a portion of the first trajectory O11 arranged in the first non-overlapping region R111b and a portion of the second trajectory O12 arranged in the second non-overlapping region R121b cross at one location when the first trajectory O11 and the second trajectory O12 are viewed in the T-axis direction. On the other hand, the portion of the first trajectory O11 arranged in the first non-overlapping region R111b and the portion of the second trajectory O12 arranged in the second non-overlapping region R121b do not have portions extending in the same direction. It is assumed in the present specification that the first non-overlapping region R111b does not face (therefore, does not overlap) the second circling trajectory portion R121 in a case where the portion of the first trajectory O11 arranged in the first non-overlapping region R111b and the portion of the second trajectory O12 arranged in the second non-overlapping region R121b do not have portions extending in the same direction even if the portions cross each other when the first trajectory O11 and the second trajectory O12 are viewed in the T-axis direction. Similarly, it is assumed in the present specification that the third non-overlapping region R131b does not face (therefore, does not overlap) the fourth circling trajectory portion R141b in a case where a portion of the third trajectory O13 arranged in the third non-overlapping region R131b and a portion of the fourth trajectory O14 arranged in the fourth non-overlapping region R141b do not have portions extending in the same direction even if the portions cross each other when the third trajectory O13 and the fourth trajectory O14 are viewed in the T-axis direction.

### 2-2-3. Magnetic Coupling of First Coil Conductor and Second Coil Conductor

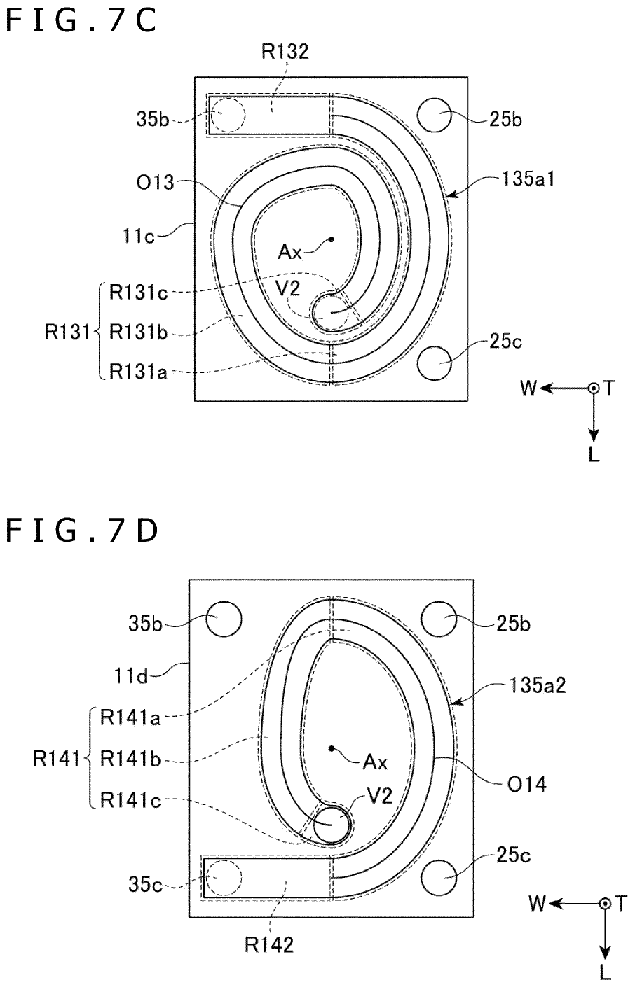

The magnetic coupling of the first coil conductor 125 and the second coil conductor 135 will be described mainly with reference to FIG. 8. FIG. 8 illustrates a cross section of the magnetic coupling coil component 101 taken along a line III-III. FIG. 8 illustrates a cross section of the magnetic coupling coil component 101 cut in a plane parallel to the WT surface.

As illustrated in FIG. 8, the first overlapping region R111a and the second overlapping region R121a face the third non-overlapping region R131b in the axial direction (T-axis direction) along the coil axis Ax. As described above, the third non-overlapping region R131b does not face the fourth circling trajectory portion R141 of the second lower conductor pattern 135a2, and therefore, the conductor pattern included in the second lower conductor pattern 135a2 is not arranged below the third non-overlapping region R131b in the T-axis direction. The interlinkage flux F1 generated from the first overlapping region R111a and the second overlapping region R121a due to a change in the current flowing through the first coil conductor 125 can pass below the third non-overlapping region R131b, which is part of the second upper conductor pattern 135a1 arranged above the second lower conductor pattern 135a2, and return to near the first coil conductor 125 without advancing to below the second lower conductor pattern 135a2. In this way, according to the magnetic coupling coil component 101, the first overlapping region R111a and the second overlapping region R121a face the third non-overlapping region R131b in the axial direction along the coil axis Ax, and therefore, the length of the magnetic path of the interlinkage flux generated from the first coil conductor 125 and interlinked with the second coil conductor 135 can be shorter than that in a mode in which the interlinkage flux generated from the first coil conductor 125 passes below the second lower conductor pattern 135a2.

The third overlapping region R131a and the fourth overlapping region R141a face the second non-overlapping region R121b in the axial direction (T-axis direction) along the coil axis Ax. As described above, the second non-overlapping region R121b does not face the first circling trajectory portion R111 of the first upper conductor pattern 125a1, and therefore, the conductor pattern included in the first upper conductor pattern 125a1 is not arranged above the second non-overlapping region R121b in the T-axis direction. The interlinkage flux F2 generated from the third overlapping region R131a and the fourth overlapping region R141a due to a change in the current flowing through the second coil conductor 135 can pass above the second non-overlapping region R121b, which is part of the first lower conductor pattern 125a2 arranged below the first upper conductor pattern 25a1, and return to near the second coil conductor 135 without advancing to above the first upper conductor pattern 125a1. In this way, according to the magnetic coupling coil component 101, the third overlapping region R131a and the fourth overlapping region R141a face the second non-overlapping region R121b in the axial direction along the coil axis Ax, and therefore, the length of the magnetic path of the interlinkage flux generated from the second coil conductor 135 and interlinked with the first coil conductor 125 can be shorter than that in a mode in which the interlinkage flux generated from the second coil conductor 135 passes above the first upper conductor pattern 125a1.

The coil component 101 is manufactured according to the manufacturing method of the coil component 1.

### 3. Third Embodiment

Next, an array coil component 301 including a plurality of magnetic coupling coil components 1 packaged as one element will be described.

### 3-1. Background

A plurality of coils are packaged as one element in an array coil component, and this is generally advantageous in that the mount space for mounting the plurality of coils on a board can be reduced.

However, if the distance between adjacent magnetic coupling coil components is small in the array coil component including a plurality of packaged magnetic coupling coil components, undesirable magnetic coupling between the adjacent magnetic coupling coil components becomes large, and each magnetic coupling coil component may not exhibit expected characteristics.

Therefore, the intervals between the adjacent magnetic coupling coil components are increased in the existing array coil component to weaken the magnetic coupling between the adjacent magnetic coupling coil components. However, the increase in the intervals between the adjacent magnetic coupling coil components is contrary to the original purpose of reducing the mount space in the array coil component.

Therefore, it is desirable to reduce the magnetic coupling between the adjacent magnetic coupling coil components in the array coil component including a plurality of magnetic coupling coil components.

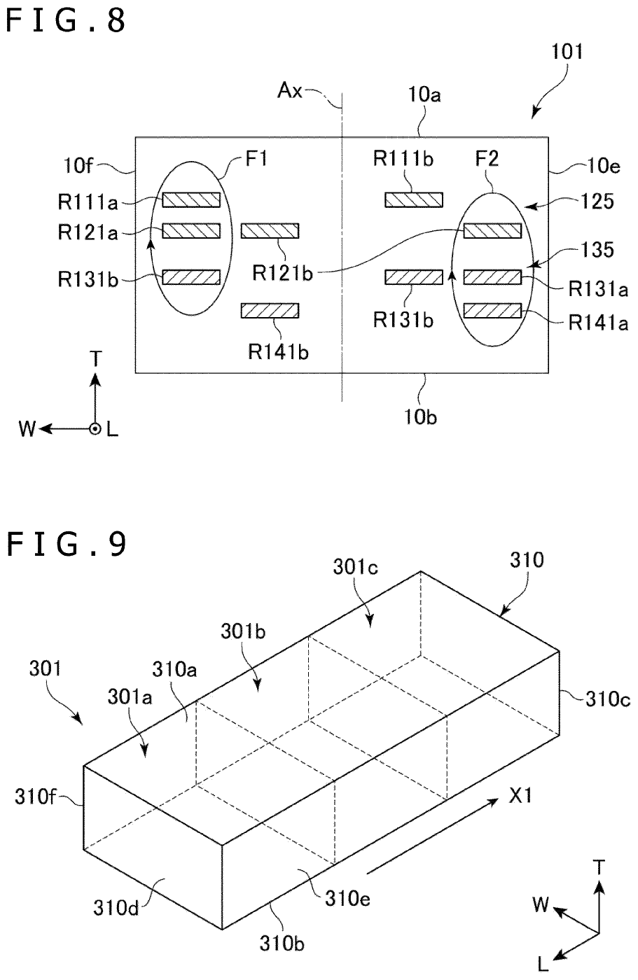

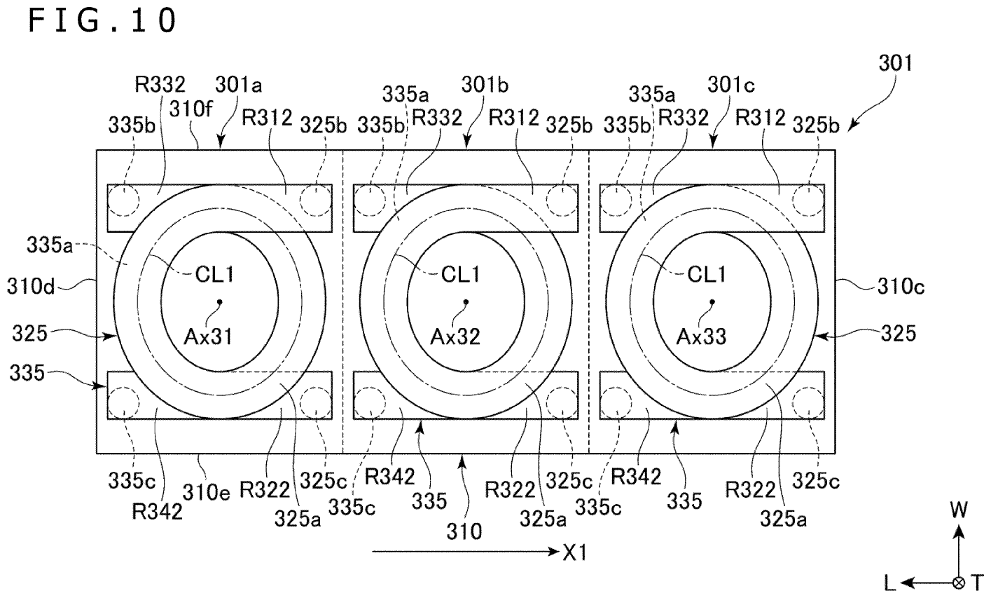

The array coil component 301 that solves or mitigates the problem will be described with reference to FIGS. 9 and 10.

### 3-2. Description of Array Coil Component 301

FIG. 9 illustrates a perspective view of the array coil component 301 according to a third embodiment, and FIG. 10 illustrates a transparent view of the array coil component 301 viewed from the upper surface. As illustrated in FIGS. 9 and 10, the array coil component 301 includes three magnetic coupling coils 301a, 301b, and 301c. The number of magnetic coupling coil components included in the array coil component 301 is not limited to three, and the number of magnetic coupling coil components may be two or may be four or more.

As illustrated in FIG. 9, the array coil component 301 includes a base 310, and coil conductors included in the respective magnetic coupling coils 301a, 301b, and 301c are provided in the base 310. The base 310 contains an insulating material as with the base 10, and the base 310 electrically insulates the respective coil conductors included in the magnetic coupling coils 301a, 301b, and 301c.

The base 310 includes an upper surface 310a, a lower surface 310b, a first end surface 310c, a second end surface 310d, a first side surface 310e, and a second side surface 310f. The configuration of the base 310 is similar to the configuration of the base 10 except that the dimension of the base 310 in the L-axis direction is increased to house the coil conductors included in the three magnetic coupling coils. The description related to the base 10 is also applied as much as possible to the base 310. For example, as in the base 10, the upper surface 310a and the lower surface 310b of the base 310 are surfaces at both ends of the base 310 in the T-axis direction. The first end surface 310c and the second end surface 310d are surfaces at both ends of the base 310 in the L-axis direction. The first side surface 310e and the second side surface 310f are surfaces at both ends of the base 310 in the W-axis direction. In FIGS. 9 and 10, an X1-axis extending parallel to the L-axis from the positive side to the negative side of the L-axis along the L-axis direction is depicted for the convenience of description.

In the illustrated embodiment, the magnetic coupling coils 301a, 301b, and 301c are arranged along the X1-axis direction parallel to the L-axis direction. That is, the magnetic coupling coil 301a, the magnetic coupling coil 301b, and the magnetic coupling coil 301c are arranged in this order along the X1-axis direction in the array coil component 301. The magnetic coupling coil 301b is arranged at a position separated from the magnetic coupling coil 301a in the X1-axis direction. Similarly, the magnetic coupling coil 301c is arranged at a position separated from the magnetic coupling coil 301b in the X1-axis direction.

In the illustrated embodiment, the magnetic coupling coil 301a includes a first coil conductor 325 and a second coil conductor 335. The first coil conductor 325 is arranged to face the upper surface 310a of the base 310, and the second coil conductor 335 is arranged to face the lower surface 310b of the base 310. As illustrated in FIG. 10, the shape of the first coil conductor 325 is the same as the shape of the first coil conductor 25, and the shape of the second coil conductor 335 is the same as the shape of the second coil conductor 35.

Although not illustrated, two external electrodes connected to both ends of the first coil conductor 325 of the magnetic coupling coil 301a and two external electrodes connected to both ends of the second coil conductor 335 are provided on the lower surface 310b of the base 310.

In the magnetic coupling coil 301a, the first coil conductor 325 includes a first circling portion 325a extending in the circumferential direction about a coil axis Ax31, a first one-end extension portion 325b that connects one end of the first circling portion 325a and a first external electrode (not illustrated), and a first other-end extension portion 325c that connects the other end of the first circling portion 325a and a second external electrode (not illustrated). The second coil conductor 335 includes a second circling portion 335a extending in the circumferential direction about the coil axis Ax31, a second one-end extension portion 335b that connects one end of the second circling portion 335a and a third external electrode (not illustrated), and a second other-end extension portion 335c that connects the other end of the second circling portion 335a and a fourth external electrode (not illustrated).

The configurations of the magnetic coupling coils 301b and 301c are similar to the configuration of the magnetic coupling coil 301a. The first circling portion 325a and the second circling portion 335a of the magnetic coupling coil 301b extend in the circumferential direction about a coil axis Ax32. The first circling portion 325a and the second circling portion 335a of the magnetic coupling coil 301c extend in the circumferential direction about a coil axis Ax33. The coil axis Ax32 is separated from the coil axis Ax31 in the X1-axis direction. The coil axis Ax33 is separated from the coil axis Ax32 in the X1-axis direction.

In each of the magnetic coupling coils 301a, 301b, and 301c, the first coil conductor 325 includes a first connection portion R312 linearly extending in the L-axis direction (direction parallel to the X1-axis direction) from the first one-end extension portion 325b and a second connection portion R322 linearly extending in the W-axis direction from the first other-end extension portion 325c. The second coil conductor 335 includes a third connection portion R332 linearly extending in the L-axis direction (direction parallel to the X1-axis direction) from the second one-end extension portion 335b and a fourth connection portion R342 linearly extending in the W-axis direction from the second other-end extension portion 335c.

In one aspect, the first connection portion R312, the second connection portion R322, the third connection portion R332, and the fourth connection portion R342 extend along the X1-axis direction in the magnetic coupling coil 301a. Therefore, the magnetic flux generated by a change in the current flowing through the first coil conductor 325 and the second coil conductor 335 is more likely to flow in the direction orthogonal to the X1-axis. In this way, while the magnetic coupling coil 301a and the magnetic coupling coil 301b are arranged along the X1-axis direction, the magnetic coupling coil 301a and the magnetic coupling coil 301b are formed and arranged such that the magnetic flux generated from the first coil conductor 325 and the second coil conductor 335 of the magnetic coupling coil 301a is more likely to flow in the direction orthogonal to the X1-axis direction. Therefore, the magnetic flux generated from the first coil conductor 325 and the second coil conductor 335 of the magnetic coupling coil 301a is less likely to be interlinked with the magnetic coupling coil 301b adjacent to the magnetic coupling coil 301a in the X1-axis direction, and this can suppress undesirable magnetic coupling of the magnetic coupling coil 301a and the magnetic coupling coil 301b. Similarly, the first coil conductor 325 and the second coil conductor 335 included in the magnetic coupling coil 301b are formed and arranged such that the magnetic flux generated from the first coil conductor 325 and the second coil conductor 335 is more likely to flow in the direction orthogonal to the X1-axis direction. Therefore, the magnetic flux generated from the first coil conductor 325 and the second coil conductor 335 of the magnetic coupling coil 301b is less likely to be interlinked with the magnetic coupling coil 301a and the magnetic coupling coil 301c adjacent to the magnetic coupling coil 301b, and this can suppress undesirable magnetic coupling of the magnetic coupling coil 301b to the magnetic coupling coil 301a and the magnetic coupling coil 301c.

The description related to the first coil conductor 25 included in the magnetic coupling coil component 1 is also applied as much as possible to the first coil conductor 325. The description related to the second coil conductor 35 included in the magnetic coupling coil component 1 is also applied as much as possible to the second coil conductor 335.

### 4. Combinations of Embodiments

Modes obtained by combining the embodiments described in the present specification are also included in the embodiments disclosed in the specification of the present application.

The first to third embodiments can be combined in various manners understood by those skilled in the art on the basis of the description of the specification of the present application. For example, the second and third embodiments can be combined to provide the magnetic coupling coils 301a, 301b, and 301c as planar coils, and the array coil component 301 can include the magnetic coupling coils 301a, 301b, and 301c provided as planar coils.

Possible combinations of the embodiments are not limited to the combinations clearly described in the present specification. The first to third embodiments can be combined as desired.

### 5. Note

The dimension, material, and arrangement of each constituent element described in the above-mentioned various embodiments are not limited to those explicitly described in the embodiments, and each constituent element can be modified to have any dimension, material, and arrangement that can be included in the scope of the present technology. For example, at least one of the first circling trajectory portion R11, the second circling trajectory portion R21, the third circling trajectory portion R31, and the fourth circling trajectory portion R41 may extend 0.75 turns or more about the coil axis Ax.

Constituent elements not explicitly described in the present specification may also be added to the embodiments, and some of the constituent elements described in the embodiments may also be removed.

The terms such as “first,” “second,” and “third” in the present specification are given to identify the constituent elements, and the terms do not necessarily limit the numbers, the orders, and the details of the constituent elements. In addition, the numbers for identifying the constituent elements are used on the basis of context, and the numbers used in one context may not represent the same components in another context. Moreover, the constituent elements identified by numbers may also have functions of the constituent elements identified by other numbers.

### 6. Supplements

The embodiments disclosed in the present specification also include the following items.

### [Supplement 1]

A magnetic coupling coil component including:
a base containing an insulating material and including a first surface and a second surface facing the first surface;
a first coil conductor provided in the base to face the first surface; and
a second coil conductor provided in the base to face the second surface, in which
the first coil conductor includes
   a first conductor pattern including a first circling trajectory portion on a first trajectory extending in a circumferential direction about a coil axis, and
   a second conductor pattern that is arranged separately from the first conductor pattern in an axial direction along the coil axis and that includes a second circling trajectory portion on a second trajectory extending in the circumferential direction about the coil axis,
the first circling trajectory portion includes
   a first overlapping region facing the second circling trajectory portion in the axial direction, and
   a first non-overlapping region not facing the second circling trajectory portion in the axial direction,
the second circling trajectory portion includes
   a second overlapping region facing the first circling trajectory portion in the axial direction, and
   a second non-overlapping region not facing the first circling trajectory portion in the axial direction,
the second coil conductor includes
   a third conductor pattern including a third circling trajectory portion on a third trajectory extending in the circumferential direction about the coil axis, and
   a fourth conductor pattern that is arranged separately from the third conductor pattern in the axial direction and that includes a fourth circling trajectory portion on a fourth trajectory extending in the circumferential direction about the coil axis,
the third circling trajectory portion includes
   a third overlapping region facing the fourth circling trajectory portion in the axial direction, and
   a third non-overlapping region not facing the fourth circling trajectory portion in the axial direction,
the fourth circling trajectory portion includes
   a fourth overlapping region facing the third circling trajectory portion in the axial direction, and
   a fourth non-overlapping region not facing the third circling trajectory portion in the axial direction, and
the first overlapping region and the second overlapping region face the third non-overlapping region in the axial direction.

### [Supplement 2]

The magnetic coupling coil component according to [Supplement 1], in which
the third overlapping region and the fourth overlapping region face the second non-overlapping region in the axial direction.

### [Supplement 3]

The magnetic coupling coil component according to [Supplement 1] or [Supplement 2], in which
the third conductor pattern is arranged to face the second conductor pattern.

### [Supplement 4]

The magnetic coupling coil component according to any one of [Supplement 1] to [Supplement 3], in which
the first coil conductor includes
   a first circling portion including the first conductor pattern and the second conductor pattern,
   a first one-end extension portion extending from one end of the first circling portion to the second surface, and
   a first other-end extension portion extending from another end of the first circling portion to the second surface, and
the second coil conductor includes
   a second circling portion including the third conductor pattern and the fourth conductor pattern,
   a second one-end extension portion extending from one end of the second circling portion to the second surface, and
   a second other-end extension portion extending from another end of the second circling portion to the second surface.

### [Supplement 5]

The magnetic coupling coil component according to [Supplement 4], in which
the first conductor pattern and the second conductor pattern are connected to each other by a first via conductor extending along the axial direction, and
the third conductor pattern and the fourth conductor pattern are connected to each other by a second via conductor extending along the axial direction.

### [Supplement 6]

The magnetic coupling coil component according to [Supplement 5], in which
one end of the first conductor pattern is connected to the first via conductor,
another end of the first conductor pattern is connected to the first one-end extension portion,
one end of the second conductor pattern is connected to the first via conductor,
another end of the second conductor pattern is connected to the first other-end extension portion,
one end of the third conductor pattern is connected to the second via conductor,
another end of the third conductor pattern is connected to the second one-end extension portion,
one end of the fourth conductor pattern is connected to the second via conductor, and
another end of the fourth conductor pattern is connected to the second other-end extension portion.

### [Supplement 7]

The magnetic coupling coil component according to any one of [Supplement 1] to [Supplement 6], in which
each of the first circling trajectory portion, the second circling trajectory portion, the third circling trajectory portion, and the fourth circling trajectory portion extends 0.75 or more turns in the circumferential direction.

### [Supplement 8]

The magnetic coupling coil component according to any one of [Supplement 1] to [Supplement 7], in which
a difference between an inductance value of the first coil conductor and an inductance value of the second coil conductor is equal to or smaller than 3% of the inductance value of the first coil conductor.

### [Supplement 9]

The magnetic coupling coil component according to any one of [Supplement 1] to [Supplement 8], in which
the first conductor pattern further includes a first connection portion linearly extending between the first one-end extension portion and the first circling trajectory portion,
the second conductor pattern further includes a second connection portion linearly extending between the first other-end extension portion and the second circling trajectory portion,
the third conductor pattern further includes a third connection portion linearly extending between the second one-end extension portion and the third circling trajectory portion, and
the fourth conductor pattern further includes a fourth connection portion linearly extending between the second other-end extension portion and the fourth circling trajectory portion.

### [Supplement 10]

The magnetic coupling coil component according to any one of [Supplement 1] to [Supplement 9], in which
the first overlapping region does not face the third overlapping region and the fourth overlapping region in the axial direction.

### [Supplement 11]

An array coil component including:
a base containing an insulating material and including a first surface, a second surface (310b) facing the first surface, a third surface connecting the first surface and the second surface, and a fourth surface facing the third surface and being separated from the third surface in one axial direction;
a first magnetic coupling coil provided in the base; and
a second magnetic coupling coil provided in the base separately from the first magnetic coupling coil in the one axial direction, in which
the first magnetic coupling coil includes
   a first coil conductor provided in the base to face the first surface, and
   a second coil conductor provided in the base to face the second surface,
the first coil conductor includes a first circling portion, the first circling portion including
   a first conductor pattern including a first circling trajectory portion on a first trajectory extending in a circumferential direction about a first coil axis, and
   a second conductor pattern that is arranged separately from the first conductor pattern in a first axial direction along the first coil axis and that includes a second circling trajectory portion on a second trajectory extending in the circumferential direction about the first coil axis,
the first circling trajectory portion includes
   a first overlapping region facing the second circling trajectory portion in the first axial direction, and
   a first non-overlapping region not facing the second circling trajectory portion in the first axial direction,
the second circling trajectory portion includes
   a second overlapping region facing the first circling trajectory portion in the first axial direction, and
   a second non-overlapping region not facing the first circling trajectory portion in the first axial direction,
the second coil conductor includes a second circling portion, the second circling portion including
   a third conductor pattern including a third circling trajectory portion on a third trajectory extending in the circumferential direction about the first coil axis, and
   a fourth conductor pattern that is arranged separately from the third conductor pattern in the first axial direction and that includes a fourth circling trajectory portion on a fourth trajectory extending in the circumferential direction about the first coil axis,
the third circling trajectory portion includes
   a third overlapping region facing the fourth circling trajectory portion in the first axial direction, and
   a third non-overlapping region not facing the fourth circling trajectory portion in the first axial direction,
the fourth circling trajectory portion includes
   a fourth overlapping region facing the third circling trajectory portion in the first axial direction, and
   a fourth non-overlapping region not facing the third circling trajectory portion in the first axial direction,
the first overlapping region and the second overlapping region face the third non-overlapping region in the first axial direction,
the second magnetic coupling coil includes
   a third coil conductor provided in the base to face the first surface, and
   a fourth coil conductor provided in the base to face the second surface,
the third coil conductor includes a third circling portion, the third circling portion including
   a fifth conductor pattern including a fifth circling trajectory portion on a fifth trajectory extending in a circumferential direction about a second coil axis (Ax32) separated from the first coil axis in the one axial direction, and
   a sixth conductor pattern that is arranged separately from the fifth conductor pattern in a second axial direction along the second coil axis and that includes a sixth circling trajectory portion on a sixth trajectory extending in the circumferential direction about the second coil axis,
the fifth circling trajectory portion includes
   a fifth overlapping region facing the sixth circling trajectory portion in the second axial direction, and
   a fifth non-overlapping region not facing the sixth circling trajectory portion in the second axial direction,
the sixth circling trajectory portion includes
   a sixth overlapping region facing the fifth circling trajectory portion in the second axial direction, and
   a sixth non-overlapping region not facing the fifth circling trajectory portion in the second axial direction,
the fourth coil conductor includes a fourth circling portion, the fourth circling portion including
   a seventh conductor pattern including a seventh circling trajectory portion on a seventh trajectory extending in the circumferential direction about the second coil axis, and
   an eighth conductor pattern that is arranged separately from the seventh conductor pattern in the second axial direction and that includes an eighth circling trajectory portion on an eighth trajectory extending in the circumferential direction about the second coil axis,
the seventh circling trajectory portion includes
   a seventh overlapping region facing the eighth circling trajectory portion in the second axial direction, and
   a seventh non-overlapping region not facing the eighth circling trajectory portion in the second axial direction,
the eighth circling trajectory portion includes
   an eighth overlapping region facing the seventh circling trajectory portion in the second axial direction, and
   an eighth non-overlapping region not facing the seventh circling trajectory portion in the second axial direction, and
the fifth overlapping region and the sixth overlapping region face the seventh non-overlapping region in the axial direction.

### [Supplement 12]

A circuit board including:
the magnetic coupling coil component according to any one of [Supplement 1] to [Supplement 11].

### [Supplement 13]

An electronic component including:
the circuit board according to [Supplement 12].

What is claimed is:

1. A magnetic coupling coil component comprising:
a base (10) containing an insulating material and including a first surface (10a) and a second surface (10b) facing the first surface;
a first coil conductor (25) provided in the base to face the first surface (10a); and
a second coil conductor (35) provided in the base to face the second surface (10b), wherein
the first coil conductor includes
a first conductor pattern (25a1) including a first circling trajectory portion (R11) on a first trajectory (O1) extending in a circumferential direction about a coil axis (Ax), and
a second conductor pattern (25a2) that is arranged separately from the first conductor pattern in an axial direction along the coil axis and that includes a second circling trajectory portion on a second trajectory (O2) extending in the circumferential direction about the coil axis,
the first circling trajectory portion includes
a first overlapping region (R11a) facing the second circling trajectory portion in the axial direction, and
a first non-overlapping region (R11b) not facing the second circling trajectory portion in the axial direction,
the second circling trajectory portion includes
a second overlapping region (R21a) facing the first circling trajectory portion in the axial direction, and
a second non-overlapping region (R21b) not facing the first circling trajectory portion in the axial direction,
the second coil conductor includes
a third conductor pattern (35a1) including a third circling trajectory portion (R31) on a third trajectory (O3) extending in the circumferential direction about the coil axis, and
a fourth conductor pattern (35a2) that is arranged separately from the third conductor pattern in the axial direction and that includes a fourth circling trajectory portion (R41) on a fourth trajectory (O4) extending in the circumferential direction about the coil axis,
the third circling trajectory portion includes
a third overlapping region (R31a) facing the fourth circling trajectory portion in the axial direction, and
a third non-overlapping region (R31b) not facing the fourth circling trajectory portion in the axial direction,
the fourth circling trajectory portion includes
a fourth overlapping region (R41a) facing the third circling trajectory portion in the axial direction, and
a fourth non-overlapping region (R41b) not facing the third circling trajectory portion in the axial direction, and
the first overlapping region (R11a) and the second overlapping region (R21a) face the third non-overlapping region (R31b) in the axial direction.

2. The magnetic coupling coil component according to claim 1, wherein
the third overlapping region (R31a) and the fourth overlapping region (R41a) face the second non-overlapping region (R21b) in the axial direction.

3. The magnetic coupling coil component according to claim 1, wherein
the third conductor pattern is arranged to face the second conductor pattern.

4. The magnetic coupling coil component according to claim 1, wherein
the first coil conductor includes
a first circling portion (25a) including the first conductor pattern and the second conductor pattern,
a first one-end extension portion extending from one end of the first circling portion to the second surface, and
a first other-end extension portion extending from another end of the first circling portion to the second surface, and
the second coil conductor includes
a second circling portion (35a) including the third conductor pattern and the fourth conductor pattern,
a second one-end extension portion extending from one end of the second circling portion to the second surface, and
a second other-end extension portion extending from another end of the second circling portion to the second surface.

5. The magnetic coupling coil component according to claim 4, wherein
the first conductor pattern and the second conductor pattern are connected to each other by a first via conductor extending along the axial direction, and
the third conductor pattern and the fourth conductor pattern are connected to each other by a second via conductor extending along the axial direction.

6. The magnetic coupling coil component according to claim 5, wherein
one end of the first conductor pattern is connected to the first via conductor,
another end of the first conductor pattern is connected to the first one-end extension portion,
one end of the second conductor pattern is connected to the first via conductor,
another end of the second conductor pattern is connected to the first other-end extension portion,
one end of the third conductor pattern is connected to the second via conductor,
another end of the third conductor pattern is connected to the second one-end extension portion,
one end of the fourth conductor pattern is connected to the second via conductor, and
another end of the fourth conductor pattern is connected to the second other-end extension portion.

7. The magnetic coupling coil component according to claim 1, wherein
each of the first circling trajectory portion, the second circling trajectory portion, the third circling trajectory portion, and the fourth circling trajectory portion extends 0.75 or more turns in the circumferential direction.

8. The magnetic coupling coil component according to claim 1, wherein
a difference between an inductance value of the first coil conductor and an inductance value of the second coil conductor is equal to or smaller than 3% of the inductance value of the first coil conductor.

9. The magnetic coupling coil component according to claim 4, wherein
the first conductor pattern further includes a first connection portion (R12) linearly extending between the first one-end extension portion and the first circling trajectory portion,
the second conductor pattern further includes a second connection portion (R21) linearly extending between the first other-end extension portion and the second circling trajectory portion,
the third conductor pattern further includes a third connection portion (R31) linearly extending between the second one-end extension portion and the third circling trajectory portion, and
the fourth conductor pattern further includes a fourth connection portion (R41) linearly extending between the second other-end extension portion and the fourth circling trajectory portion.

10. The magnetic coupling coil component according to claim 1, wherein
the first overlapping region does not face the third overlapping region and the fourth overlapping region in the axial direction.

11. An array coil component comprising:
a base (310) containing an insulating material and including a first surface (310a), a second surface (310b) facing the first surface, a third surface (310c) connecting the first surface and the second surface, and a fourth surface (310d) facing the third surface and being separated from the third surface in one axial direction (X1-axis);
a first magnetic coupling coil (301a) provided in the base; and
a second magnetic coupling coil (301b) provided in the base separately from the first magnetic coupling coil in the one axial direction, wherein
the first magnetic coupling coil includes
a first coil conductor provided in the base to face the first surface, and
a second coil conductor provided in the base to face the second surface,
the first coil conductor includes a first circling portion, the first circling portion including
a first conductor pattern including a first circling trajectory portion on a first trajectory extending in a circumferential direction about a first coil axis (Ax31), and
a second conductor pattern that is arranged separately from the first conductor pattern in a first axial direction along the first coil axis and that includes a second circling trajectory portion on a second trajectory extending in the circumferential direction about the first coil axis,
the first circling trajectory portion includes
a first overlapping region facing the second circling trajectory portion in the first axial direction, and
a first non-overlapping region not facing the second circling trajectory portion in the first axial direction,
the second circling trajectory portion includes
a second overlapping region facing the first circling trajectory portion in the first axial direction, and
a second non-overlapping region not facing the first circling trajectory portion in the first axial direction,
the second coil conductor includes a second circling portion, the second circling portion including
a third conductor pattern including a third circling trajectory portion on a third trajectory extending in the circumferential direction about the first coil axis, and
a fourth conductor pattern that is arranged separately from the third conductor pattern in the first axial direction and that includes a fourth circling trajectory portion on a fourth trajectory extending in the circumferential direction about the first coil axis,
the third circling trajectory portion includes
a third overlapping region facing the fourth circling trajectory portion in the first axial direction, and
a third non-overlapping region not facing the fourth circling trajectory portion in the first axial direction,
the fourth circling trajectory portion includes
a fourth overlapping region facing the third circling trajectory portion in the first axial direction, and
a fourth non-overlapping region not facing the third circling trajectory portion in the first axial direction,
the first overlapping region and the second overlapping region face the third non-overlapping region in the first axial direction,
the second magnetic coupling coil includes
a third coil conductor provided in the base to face the first surface, and
a fourth coil conductor provided in the base to face the second surface,
the third coil conductor includes a third circling portion, the third circling portion including
a fifth conductor pattern including a fifth circling trajectory portion on a fifth trajectory extending in a circumferential direction about a second coil axis (Ax32) separated from the first coil axis in the one axial direction, and
a sixth conductor pattern that is arranged separately from the fifth conductor pattern in a second axial direction along the second coil axis and that includes a sixth circling trajectory portion on a sixth trajectory extending in the circumferential direction about the second coil axis,
the fifth circling trajectory portion includes
a fifth overlapping region facing the sixth circling trajectory portion in the second axial direction, and
a fifth non-overlapping region not facing the sixth circling trajectory portion in the second axial direction,
the sixth circling trajectory portion includes
a sixth overlapping region facing the fifth circling trajectory portion in the second axial direction, and
a sixth non-overlapping region not facing the fifth circling trajectory portion in the second axial direction,
the fourth coil conductor includes a fourth circling portion, the fourth circling portion including
a seventh conductor pattern including a seventh circling trajectory portion on a seventh trajectory extending in the circumferential direction about the second coil axis, and
an eighth conductor pattern that is arranged separately from the seventh conductor pattern in the second axial direction and that includes an eighth circling trajectory portion on an eighth trajectory extending in the circumferential direction about the second coil axis,
the seventh circling trajectory portion includes
a seventh overlapping region facing the eighth circling trajectory portion in the second axial direction, and
a seventh non-overlapping region not facing the eighth circling trajectory portion in the second axial direction,
the eighth circling trajectory portion includes
an eighth overlapping region facing the seventh circling trajectory portion in the second axial direction, and
an eighth non-overlapping region not facing the seventh circling trajectory portion in the second axial direction, and
the fifth overlapping region and the sixth overlapping region face the seventh non-overlapping region in the axial direction.
